(19) United States
(12) Patent Application Publication
(10) Pub. No.: US 2007/0002382 A1
(43) Pub. Date: Jan. 4, 2007

(54) Image processing method and apparatus, image forming apparatus, and method and program of creating dot pattern adjacency table

(75) Inventor: Yoshirou Yamazaki, Ashigara-Kami-Gun (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/475,895

(22) Filed: Jun. 28, 2006

(30) Foreign Application Priority Data
Jun. 29, 2005 (JP) 2005-189984

(51) Int. Cl. G06K 15/00

(52) U.S. Cl. 358/3.03

(57) ABSTRACT

The image processing method converts an input image in which multiple-value gradation values are assigned to pixels, into a dot image, by performing processing for converting each of the pixels of the input image into a dot pattern of a pixel block composed of a plurality of binary pixels. The dot pattern of a pixel under consideration is specified according to the gradation value of the pixel under consideration in the input image, the gradation values of at least two processed adjacent pixels that are adjacent to the pixel under consideration, and the dot patterns of the at least two processed adjacent pixels.

### BACKGROUND OF THE INVENTION

1. Field of the Invention

The present invention relates to an image processing method and apparatus, an image forming apparatus, and a method and a program of creating a dot pattern adjacency table, and more particularly to halftoning technology suitable for an inkjet printer, or the like.

2. Description of the Related Art

When recording an image by means of an inkjet printer, image processing is carried out in order to convert the inputted multiple-value image data into binary image data (namely, data indicating the presence or absence of dots). A density pattern method is one known method for a halftoning process of this kind (see Japanese Patent Application Publication Nos. 2004-179957 and 2004-88363).

As described in Japanese Patent Application Publication No. 2004-179957, in order to represent multiple tone gradations by means of an image output system that is only capable of representing each pixel in terms of a binary value, the density pattern method is a method which represents multiple tone gradations by means of a density pattern (dot pattern) expressed by pixel blocks which comprise a collection of a plurality of binary pixels.

For example, as described in Japanese Patent Application Publication No. 2004-88363, one pixel which represents tonal gradations as multiple values is associated with a pixel section (dot pattern) comprising n×n sub-pixels (where n is a natural number larger than 1), a binary tonal gradation (having two values of dot-on and dot-off) is assigned to each sub-pixel, and the tonal gradation is represented by the number of dots in the pixel sections of the n×n pixels. According to this method, color conversion is performed in a smaller number of pixels than the print resolution, and by constituting pixels for printing by means of the sub-pixels formed by a density pattern method, it is possible to reduce the number of pixels in the image data handled by intermediate stages, thus making it possible to reduce the processing load and to increase the processing speed.

In a commonly known density pattern method, multiple-value error diffusion processing is carried out in the image resolution state, and dot patterns are selected on the basis of the result of this error diffusion; however, at the junctures (boundaries) between adjacent dot patterns, incongruities may appear in the image (in other words, periodic streaks may occur in accordance with the size of the dot patterns), due to the differences between the characteristics of the dot arrangements, thus leading to problems of image quality.

With respect to this point, Japanese Patent Application Publication No. 2004-179957 discloses technology which aims to improve the quality of an output image based on a density pattern method, by specifying the dot pattern of a particular pixel under consideration on the basis of the relationships between that pixel and the dot patterns of adjacent sub-pixels. However, if the dot arrangement of a sub-pixel adjacent to the pixel under consideration is the same and the pixel value (tonal gradation value) of the pixel under consideration is the same, then in a flat (solid) image in which the same pixel value is continued, for example, the same dot pattern is selected for the position under consideration and is repeated.

In this respect, looking at a dot pattern obtained by successfully performed error diffusion processing (or blue noise mask processing) for the purpose of comparison, even in cases where the pixel value under consideration and the adjacent pixel value are the same, since the pixel values in further outer positions also have an effect, then the dot pattern at the pixel position under consideration is not necessarily be the same in all cases. Furthermore, it can be seen that the dot pattern of the adjacent pixel position is not necessarily be the same, either. In other words, when generating a high-quality image on a par with successfully performed error diffusion processing, information relating to the adjacent pixel values and the pixel value under consideration is not sufficient on its own, and furthermore, the information relating to the dot patterns of the sub-pixels of the adjacent pixel positions and the pixel under consideration as described in Japanese Patent Application Publication No. 2004-179957 is not sufficient either.

From this viewpoint, if the range of the adjacent pixels is to be extended further to the outer side, then the combinations of pixel values multiply exponentially and a huge number of combinations become involved. For example, if the adjacent pixel values are extended to 9 pixels, then there are 256⁹ (≈4.72×10²¹) combinations.

### SUMMARY OF THE INVENTION

The present invention has been contrived in view of the foregoing circumstances, an object thereof being to provide an image processing method and apparatus, an image forming apparatus and a method and program for creating a dot pattern adjacency table used in same, capable of achieving both high-speed execution of a density pattern method and high image quality on a par with an error diffusion method (or a blue noise mask method).

In order to attain the aforementioned object, the present invention is directed to an image processing method which converts an input image in which multiple-value gradation values are assigned to pixels, into a dot image, by performing processing for converting each of the pixels of the input image into a dot pattern of a pixel block composed of a plurality of binary pixels, wherein the dot pattern of a pixel under consideration is specified according to the gradation value of the pixel under consideration in the input image, the gradation values of at least two processed adjacent pixels that are adjacent to the pixel under consideration, and the dot patterns of the at least two processed adjacent pixels.

According to the present invention, when converting the pixels of an input image into a dot pattern based on a density pattern method (in which tonal gradations are represented by means of dot arrangements in pixel blocks each comprising a collection of a plurality of binary value sub-pixels), the dot pattern for a pixel under consideration is specified on the basis of the gradation values (in other words, the original image information) and the dot patterns of at least two processed adjacent pixels which are adjacent to the pixel under consideration, as well as the gradation value for the pixel under consideration, and therefore, it is possible to specify an appropriate dot pattern for the pixel under consideration, by taking account of the characteristics of the input image (for example, the image circumstances peripheral to the pixel under consideration, such as whether the periphery of the pixel under consideration is flat, whether it is situated in a tonal gradation, whether the image has sudden changes, such as edges, and the like), as well as matching with the adjacent dot patterns. Accordingly, it is possible to obtain a dot image of high quality.

Preferably, processing for converting into the dot patterns is carried out successively while moving the pixel under consideration in a prescribed scanning direction and processing sequence in the input image.

Since the dot pattern for the pixel under consideration is specified by using the processing results for adjacent pixels, a desirable mode is one in which the pixel conversion processing is carried out successively in a prescribed order sequence, following the pixel arrangement in the input image. Accordingly, it is possible to perform, in advance, the processing of the adjacent pixels required in the dot pattern conversion for the pixel under consideration.

Preferably, resolution of the input image and resolution of the dot image have a resolution ratio relationship which corresponds to a size of the dot patterns.

For example, if the resolution R_{OUT} of the output image (dot image) after conversion is taken to be 2400 dpi×2400 dpi, and the size of the pixel blocks of binary pixels (sub-pixels), which are the basic conversion unit, (namely, the size of the dot patterns) is taken to be 4×4 pixels, then the resolution R_{IN} of the input image is 600 dpi×600 dpi.

According to this resolution ratio relationship, the processing load for the input image can be reduced, while achieving high resolution in the output image.

Preferably, at least one dot pattern is prepared in advance for each of the gradation values, and the dot pattern for the pixel under consideration is specified from the dot patterns by using a dot pattern adjacency table which defines adjacency relationships between dot patterns that are capable of being arranged in mutually adjacent positions on the dot image.

By selecting a dot pattern which matches the conditions, by using a dot pattern adjacency table that includes previously discovered dot patterns and adjacency relationships, it is possible to improve the speed of calculational processing yet further.

Preferably, the two processed adjacent pixels are an upper side adjacent pixel positioned in an upward direction from the pixel under consideration, and a left-hand side adjacent pixel positioned in a leftward direction from the pixel under consideration, in a pixel arrangement plane of the input image.

The positions of the adjacent pixels to be taken into account are set according to the processing sequence of the pixels (namely, the direction and order in which the pixel under consideration is changed), but as one embodiment of the adjacency relationships, there is a mode which takes account of the adjacent pixels situated in an upper position and a left-hand side position in the image plane with respect to the pixel under consideration.

In order to attain the aforementioned object, the present invention is also directed to an image processing apparatus, comprising: an image input device which captures an input image in which multiple-value gradation values are assigned to pixels; a dot pattern conversion processing device which carries out processing for converting each of the pixels of the input image into a dot pattern of a pixel block composed of a plurality of binary pixels, the dot pattern conversion processing device including a dot pattern specifying device which specifies the dot pattern of the pixel under consideration according to the gradation value of the pixel under consideration in the input image, the gradation values of at least two processed adjacent pixels that are adjacent to the pixel under consideration, and the dot patterns of the at least two processed adjacent pixels; and a dot image output device which outputs a dot image obtained by means of processing performed by the dot pattern conversion processing device.

According to the image processing apparatus of the present invention, it is possible to achieve both high-speed processing and high-quality representation of tonal gradations.

Preferably, the dot pattern specifying device has a dot pattern adjacency table which defines the dot patterns usable for each of the gradation values, and adjacency relationships allowable between the dot patterns; and the dot pattern for the pixel under consideration is specified by using the dot pattern adjacency table.

By previously creating a dot pattern adjacency table which includes dot patterns capable of achieving a dot image of desirable quality, and information on the adjacency relationships between these dot patterns, and by converting an input image into a dot image on the basis of this dot pattern adjacency table, it is possible to generate a dot image of high quality, at high speed.

Preferably, the image processing apparatus further comprises a storage device which stores a relative positional relationship with a position of the pixel under consideration, in an association with the dot patterns.

A desirable mode is one in which a storage device is provided for storing the positional relationships of the processed pixels (adjacent pixels) which are adjacent to the pixel under consideration, and the dot patterns of these processed adjacent pixels, in an associated fashion, and the information stored therein is used as necessary in carrying out the processing for specifying the dot pattern corresponding to the pixel under consideration.

In order to attain the aforementioned object, the present invention is also directed to an image forming apparatus, comprising: the above-described image processing apparatus; a recording head in which a plurality of recording elements are arranged; a conveyance device which causes the recording head and a recording medium to move relatively to each other by conveying at least one of the recording head and the recording medium; and a recording control device which controls driving of the recording elements according to dot image data obtained by processing of the image processing apparatus.

The inkjet recording apparatus according to one mode of the image forming apparatus comprises: a liquid ejection head (recording head) having a liquid droplet ejection element row in which a plurality of liquid droplet ejection elements forming recording elements are arranged in a row, each liquid droplet ejection element comprising a nozzle for ejecting an ink droplet in order to form a dot and a pressure generating device (piezoelectric element, heating element, or the like) which generates an ejection pressure; and an ejection control device which controls the ejection of liquid droplets from the liquid ejection head on the basis of the dot image data generated by the image processing apparatus. An image is formed on a recording medium by means of the liquid droplets ejected from the nozzles.

A compositional embodiment of recording head is a full line type recording head having a recording element row in which a plurality of recording elements are arranged through a length corresponding to the full width of the recording medium.

In this case, a mode may be adopted in which a plurality of relatively short recording head blocks having recording element rows which do not reach a length corresponding to the full width of the recording medium are combined and joined together, thereby forming recording element rows of a length that correspond to the full width of the recording medium.

A full line type recording head is usually disposed in a direction that is perpendicular to the relative feed direction (relative conveyance direction) of the recording medium, but a mode may also be adopted in which the recording head is disposed following an oblique direction that forms a prescribed angle with respect to the direction perpendicular to the conveyance direction.

The “recording medium” indicates a medium on which an image is recorded by means of the action of the recording head (this medium may also be called a print medium, image forming medium, image receiving medium, ejection receiving medium, or the like). This term includes various types of media, irrespective of material and size, such as continuous paper, cut paper, sealed paper, resin sheets, such as OHP sheets, film, cloth, a printed circuit board on which a wiring pattern, or the like, is formed by means of a liquid ejection head, and an intermediate transfer medium, and the like.

The conveyance device for causing the recording medium and the recording head to move relatively to each other may include a mode where the recording medium is conveyed with respect to a stationary (fixed) recording head, or a mode where a recording head is moved with respect to a stationary recording medium, or a mode where both the recording head and the recording medium are moved. When forming color images by means of an inkjet recording head, it is possible to provide type recording heads for each color of a plurality of colored inks (recording liquids), or it is possible to eject inks of a plurality of colors, from one recording head.

In order to attain the aforementioned object, the present invention is also directed to a computer readable medium having embodied thereon an image processing program for performing by a computer, the image processing program causing the computer to function as the above-described image processing apparatus.

The program for image processing according to the present invention may be used as an operating program of a central processing unit (CPU) incorporated into a printer, and it may also be used in a computer system, such as a personal computer. Furthermore, the program according to the present invention may be constituted by stand-alone applicational software, or it may be incorporated as a part of another application, such as image editing software. The program according to the present invention can be stored in a CD-ROM, a magnetic disk, or other information storage medium (external storage apparatus), and the program may be provided to a third party by means of such an information storage medium, or a download service for the program may be offered by means of a communications circuit, such as the Internet.

In order to attain the aforementioned object, the present invention is also directed to a method of creating a dot pattern adjacency table, comprising: a pattern generation step of generating dot patterns of a pixel block composed of a plurality of binary pixels, which represent a tonal gradation corresponding to a multiple-value gradation value; an adjacency relationship acquisition step of acquiring information indicating adjacency relationships between dot patterns that are capable of being arranged in mutually adjacent positions; and a registration step of registering the information indicating the adjacency relationships, and the dot patterns, in association with the gradation value, in a dot pattern adjacency table.

According to the method for creating a dot pattern adjacency table according to the present invention, it is possible to obtain a table which includes information on combinations of dot patterns (adjacency relationships between dot patterns) which do not produce problems of image quality even if they are positioned adjacently to each other on the dot image.

Preferably, the dot patterns are generated by dividing up a dot image that has been subjected to halftoning process by one of an error diffusion method and a blue noise mask method, into pixel blocks of a prescribed size, and the information indicating the adjacency relationships is obtained from an arrangement of the dot patterns on this dot image.

By fetching information on dot patterns and their adjacency relationships from a dot image obtained by means of a satisfactory halftoning process, typically, an error diffusion method or a blue noise mask method, it is possible to obtain a dot pattern adjacency table whereby images of extremely high quality can be reproduced.

In order to attain the aforementioned object, the present invention is also directed to a computer readable medium having embodied thereon a dot pattern adjacency table creating program for performing by a computer, the program comprising: a first code segment for a pattern generation step of generating dot patterns of a pixel block composed of a plurality of binary pixels, which represent a tonal gradation corresponding to a multiple-value gradation value; a second code segment for an adjacency relationship acquisition step of acquiring information indicating adjacency relationships between dot patterns that are capable of being arranged in mutually adjacent positions; and a third code segment for a registration step of registering the information indicating the adjacency relationships, and the dot patterns, in association with the gradation value, in a dot pattern adjacency table.

Similarly to the above-described program for image processing, the program for creating a dot pattern adjacency table according to the present invention may be used as an operating program of a central processing unit (CPU) incorporated into a printer, and it may also be used in a computer system, such as a personal computer. Furthermore, the program for creating a dot pattern adjacency table according to the present invention may be constituted by applicational software only, or it may be incorporated as a part of another application, such as image editing software, and the mode of providing the program may involve the use of an information recording medium (external storage apparatus), or the use of a communications circuit, such as the Internet, or the like.

According to the present invention, it is possible to achieve both high-speed processing and the generation of high-quality dot images.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a conceptual diagram showing the relationship between an input image and dot patterns based on a density pattern method;

FIG. 2 is a flowchart showing the sequence of image processing based on the density pattern method;

FIG. 3 is a schematic drawing used to describe problems of image quality in the density pattern method;

FIG. 4 is a diagram showing an embodiment of a pixel processing sequence;

FIG. 5 is a conceptual diagram of processing for converting an input image into a dot image;

FIG. 6 is a diagram showing an embodiment of a dot pattern adjacency table;

FIG. 7 is a conceptual diagram showing an embodiment of dot patterns and adjacency relationships for respective input values;

FIG. 8 is a flowchart showing the sequence of processing for converting a multiple-value image into a dot image;

FIG. 9 is a conceptual diagram of a case where a dot arrangement is represented by dot pattern adjacency relationships;

FIG. 10 is a flowchart showing the procedure of data addition processing in a dot pattern adjacency table;

FIG. 11 is a flowchart showing the procedure of data removal processing in a dot pattern adjacency table;

FIG. 12 is an illustrative diagram used for describing an embodiment of a method of evaluating adjacent dot patterns;

FIG. 13 is a diagram showing a coordinates system for calculating the two-dimensional power spectrum;

FIG. 14 is a flowchart showing the sequence of processing for compensating and completing the dot pattern adjacency table;

FIGS. 15A and 15B are flowcharts showing respectively a first embodiment and a second embodiment of a procedure for creating a dot pattern adjacency table;

FIG. 16 is a block diagram showing an embodiment of the system composition of a computer which performs the dot pattern adjacency table creating process and image processing according to an embodiment of the present invention;

FIG. 17 is a block diagram showing the composition of an image processing apparatus according to an embodiment of the present invention;

FIG. 18 is a general schematic drawing of an inkjet recording apparatus which forms one embodiment of an image forming apparatus according to the present invention;

FIG. 19 is a principal plan diagram of the peripheral area of a print unit in the inkjet recording apparatus illustrated in FIG. 18;

FIG. 20 is a plan view perspective diagram showing an embodiment of the composition of a head;

FIG. 21 is a partial enlarged view of FIG. 19;

FIG. 22 is a plan view perspective diagram showing a further embodiment of the composition of a full line head;

FIG. 23 is a cross-sectional view along line 23-23 in FIGS. 20 and 21;

FIG. 24 is an enlarged view showing an embodiment of the arrangement of ink chamber units (liquid droplet ejection elements) in a head; and

FIG. 25 is a principal block diagram showing the system configuration of the inkjet recording apparatus.

### DETAILED DESCRIPTION OF THE PREFERRED EMBODIMENTS

Description of Density Pattern Method

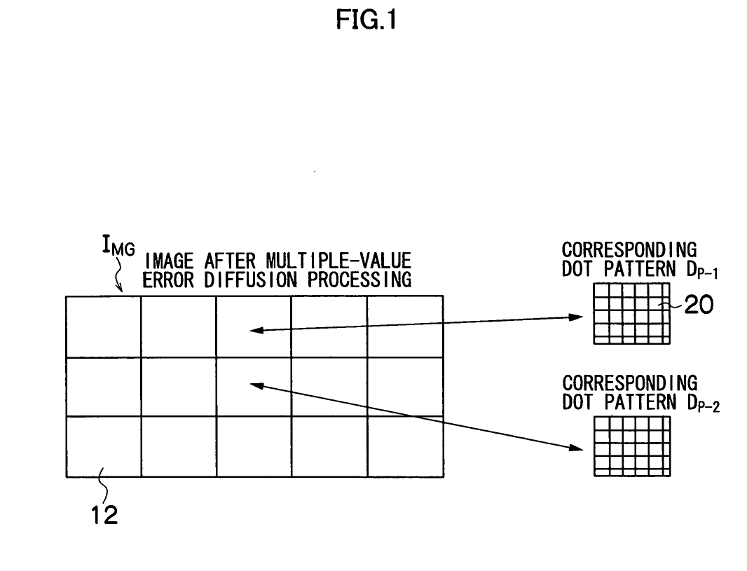

Firstly, a general description of a density pattern method is given. FIG. 1 is a conceptual diagram showing the relationship between an input image and dot patterns based on a density pattern method. The input image (multiple-tone digital image) I_{MG} before conversion to a dot image is constituted by a plurality of pixels 12, and each pixel 12 is assigned a multiple-value pixel value (tonal gradation value) which expresses a multiple-step tonal gradation. In order to simplify the drawing, FIG. 1 shows an example in which a pixel range of 3 (rows) by 5 (columns) is converted to a dot pattern.

In the density pattern method, processing is carried out to convert the tonal gradation value of one pixel position into a dot pattern (density pattern) Dₚ of a pixel block of a prescribed size. For example, one pixel position is converted into a dot pattern of a pixel block comprising m×n sub-pixels 20 (where m and n are natural numbers larger than 1).

A dot image forming the output image is obtained by converting all of the pixels 12 of the input image I_{MG} into dot patterns Dₚ corresponding respectively to the tonal gradation values of the pixels 12.

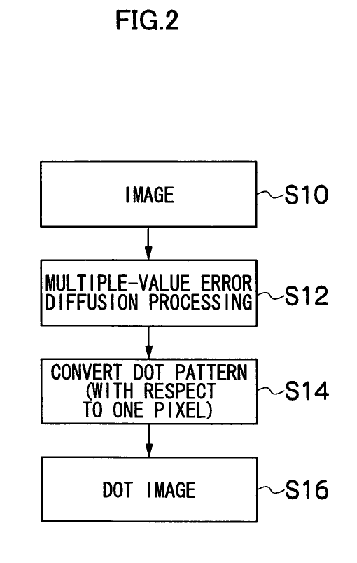

FIG. 2 shows a processing sequence of the density pattern method. As shown in FIG. 2, image data forming the processing object is input by the image input step in S10. Multiple-value error diffusion processing is carried out with respect to the input image, thereby converting the image into a prescribed number of gradations (step S12). If the prescribed number of gradations has been input previously at the time of the image input step in 10, then the processing in step S12 is not necessary. Furthermore, if the input image is not of the prescribed image resolution, then resolution conversion processing should be carried out prior to the multiple-value error diffusion processing (step S12).

The multiple-value image having a prescribed number of gradations is called the “input image G”. The pixels of the input image G are converted into a dot pattern (density pattern) corresponding to the pixel values (gradation values) (step S14). The sub-pixel range of the dot pattern to be assigned to one pixel is specified on the basis of the resolution on the output side (the printer resolution in the case of an inkjet printer). For example, taking the prescribed image resolution required at step S14 to be 600 dpi (dots per inch), and the printer resolution to be 2400 dpi, a dot pattern having a sub-pixel range of 4 (rows)×4 (columns) is adopted.

By assigning dot patterns respectively to all of the pixel positions of the input image G, a dot image (output image) O is obtained (step S16).

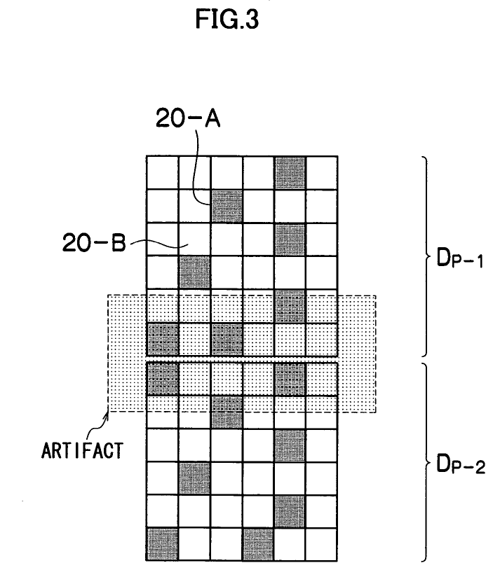

FIG. 3 is a schematic drawing showing a problem at a juncture between mutually adjacent dot patterns according to the density pattern method. FIG. 3 shows an example of the dot patterns corresponding to pixel positions which are mutually adjacent in the vertical direction. In FIG. 3, a solid black sub-pixel 20-A indicates a position where there is a dot, and a blank white sub-pixel 20-B indicates a position where there is no dot.

If the same dot pattern is repeated continuously between the adjacent pixels, then an artifact occurs in the boundary section between the adjacent dot patterns (the region surrounded by the dotted line in FIG. 3). This phenomenon also occurs similarly between dot patterns that are mutually adjacent in the lateral direction. There follows a description of an embodiment of the present invention which is effective in resolving problems of image quality at the boundary sections between adjacent dot patterns.

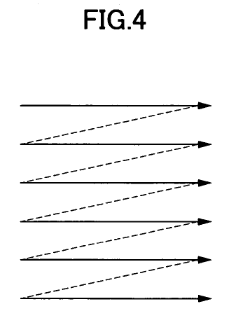

In the present embodiment, in carrying out processing for converting the respective pixels of the input image G into dot patterns, the pixels under consideration are processed successively (in a raster sequence), one pixel at a time, from left to right in the row direction of the pixels and from top to bottom in the column direction, following the arrangement sequence of the pixels, as shown in FIG. 4, by using a dot pattern adjacency table T as described hereinafter. The dot patterns that result from processing the pixels under consideration are used at the positions corresponding to the pixels under consideration, in the output image (the dot pattern output image).

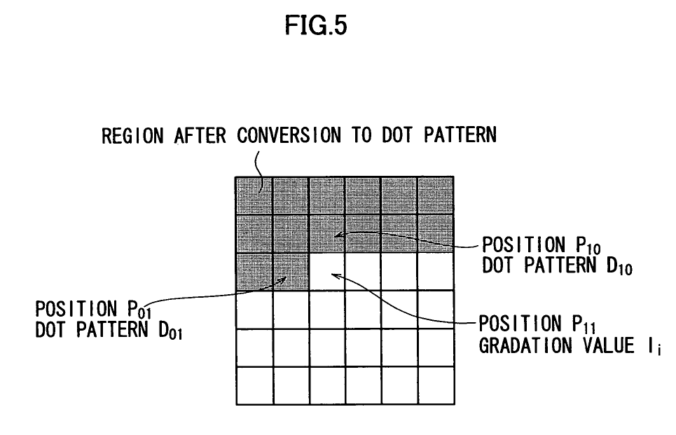

FIG. 5 is a schematic drawing showing a conceptual view of processing for converting an input image into a dot image, in a state during processing. The pixel positions that have been converted to dot patterns by successively processing the pixels under consideration in the processing sequence described in FIG. 4, are represented by gray shading in FIG. 5, and pixels that have not yet been processed are shown as white. In the example in FIG. 5, the sequential processing has progressed from the top left of the image, and the conversion processing has been completed up to position P₀₁. The next processing position (pixel for consideration) is position P₁₁.

In determining the dot pattern at position P₁₁, the information on the dot pattern D₁₀ at the position P₁₀ on the upper side, the information on the dot pattern D₀₁ at the position P₀₁ on the left-hand side, and the information on the input value (gradation value) Iᵢ at the current position P₁₁, are taken into account.

More specifically, the input values (gradation values) I₁₁, I₁₀, and I₀₁ relating respectively to the position under consideration P₁₁, the position P₁₀ situated above that position, and the position P₀₁ situated to the left-hand side of that position, are acquired, and furthermore, information relating to the specified dot patterns D₁₀ and D₀₁ is acquired with respect to position P₁₀ and position P₀₁, which have already been processed.

On the basis of these items of information, a dot pattern is specified for the pixel under consideration P₁₁, by referring to the dot pattern adjacency table T.

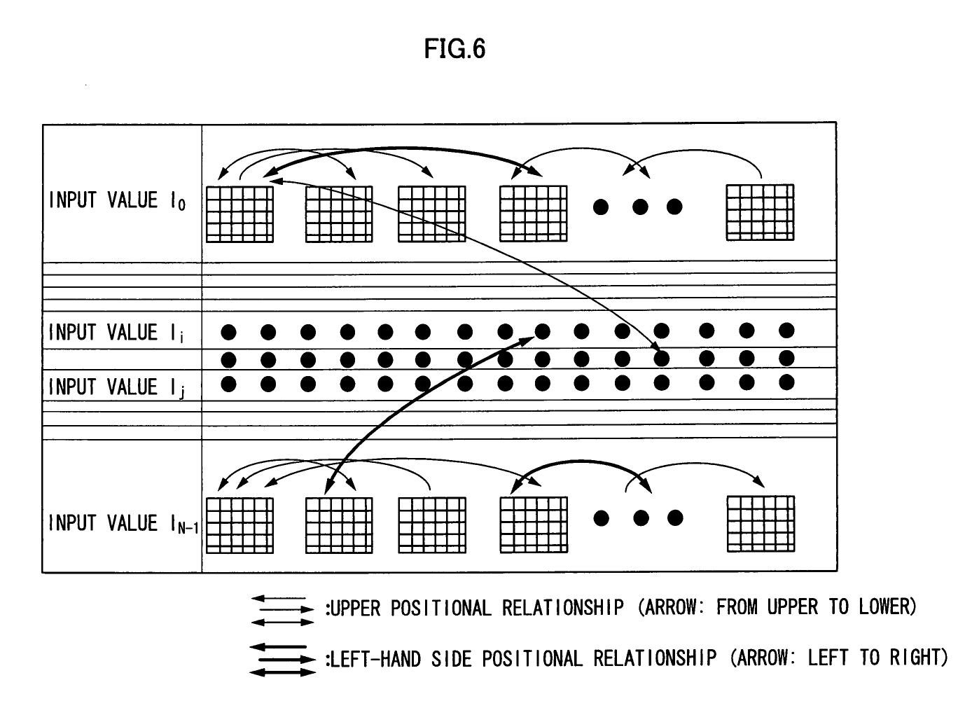

FIG. 6 is a conceptual diagram of a dot pattern adjacency table. FIG. 6 shows an embodiment of the adjacency relationships between dot patterns for N tone gradations.

In this dot pattern adjacency table T, there is at least one dot pattern (and desirably, a plurality of dot patterns) for each gradation value in the input image (in other words, for each input value) I₀ to I_{N-1}, and positional relationship associations indicating that arrangement is possible in an upper and lower positional relationship or in a left and right positional relationship are assigned between the respective dot patterns of combinations of dot patterns that do not produce an artifact such as that shown in FIG. 3 when they are mutually adjacent in an upper and lower positional relationship (or a left and right positional relationship), in such a manner that the dot patterns can be assigned according to a prescribed sequence.

Therefore, it is possible to specify the dot pattern for the position under consideration by searching the dot pattern adjacency table, on the basis of the input value of the position under consideration, and information relating to the input value and dot pattern of the position above the position under consideration (already processed), and the input value and dot pattern of the position to the left-hand side (already processed).

The thin arrows shown in FIG. 6 indicate an upper positional relationship that produces no artifact, and the thick arrows indicate a left-hand side positional relationship that produces no artifact. The dot patterns at the tips of the arrows indicate patterns that can be selected as the pattern for the pixel under consideration (which is in a lower position or a right-hand side position).

Using a dot pattern adjacency table T of this kind, when processing the pixels under consideration successively, as shown in FIG. 5, the dot pattern for a pixel under consideration is specified by combining the information relating to the respective pixel values and dot patterns of the adjacent pixels that have already been processed (the adjacent pixel in an upper position and the adjacent pixel in a left-hand side position), and the pixel value of the pixel under consideration.

When the pixel value (gradation value) and the dot pattern of the pixel adjacent on the upper side of the pixel under consideration have been specified, and the pixel value and dot pattern of the pixel adjacent on the left-hand side of the pixel under consideration have been specified, and furthermore, a pixel value has been assigned to the pixel under consideration, then the dot pattern candidates for that pixel under consideration are selected in accordance with the links indicated by the arrows in the dot pattern adjacency table T. In FIG. 6, in order to simplify the diagram, the arrows indicating the positional relationships are depicted in fewer number than a real case, and in actual practice, the situation is more complicated and a greater number of relational arrows would be drawn.

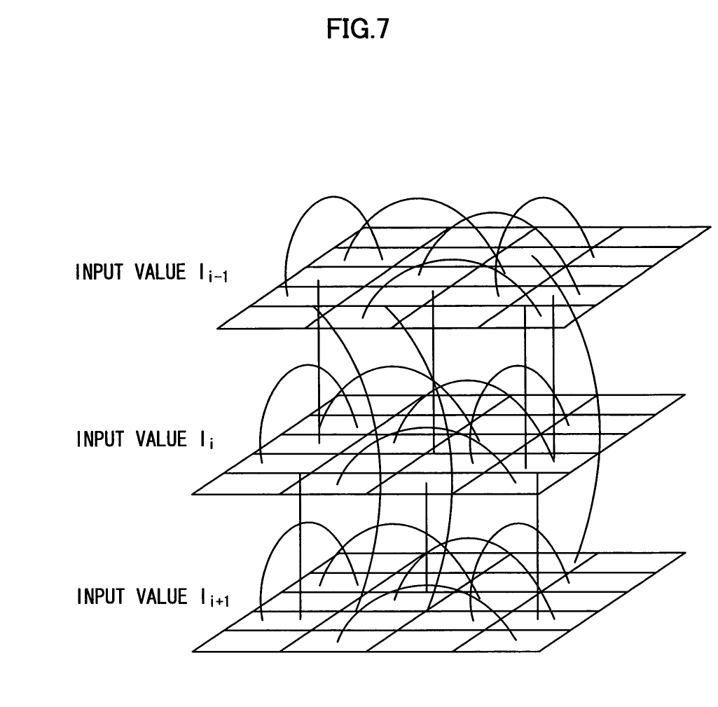

FIG. 7 shows a schematic three-dimensional view of the dot pattern adjacency table shown in FIG. 6. As shown in FIG. 7, a plurality of dot patterns are prepared respectively for each input value, and associative branch lines (the arrow lines which designate the upper/lower or left/right positional relationships shown in FIG. 6) are drawn between dot patterns which can have an adjacent positional relationship without generating an artifact. In FIG. 7, for the sake of convenience, only three levels of input value, Iᵢ₋₁, Iᵢ, Iᵢ₋₁, are depicted, but in the case of N tone gradations, adjacency relationships are defined for N−1 levels.

The dot pattern adjacency table T shown in FIGS. 6 and 7 is created previously and the respective pixel values (gradation values) I₁₁, I₁₀, and I₀₁ relating respectively to the position under consideration P₁₁, the position P₁₀ situated above that position, and the position P₀₁ situated to the left-hand side of that position in FIG. 5, are acquired, and furthermore, information relating to the specified dot patterns D₁₀ and D₀₁ is acquired with respect to the positions P₁₀ and P₀₁ which have already been processed.

On the basis of this information, in the dot pattern adjacency table T, a dot pattern group DA₁₁ is extracted, of dot patterns which belong to the gradation value I₁₁, and which have the gradation value I₁₀ and the dot pattern D₁₀ in the upper side position, and which have the gradation value I₀₁ and the dot pattern D₀₁ in the left-hand side position. If there is only one element belonging to this group DA₁₁, then that dot pattern is specified as the dot pattern for the position P₁₁. If there are a plurality of elements belonging to the group DA₁₁, then one is picked at random from the plurality of elements, and this pattern is determined as the dot pattern for position P₁₁. In the present embodiment, the actual dot patterns of the elements are thus utilized as search tags in the dot pattern adjacency table.

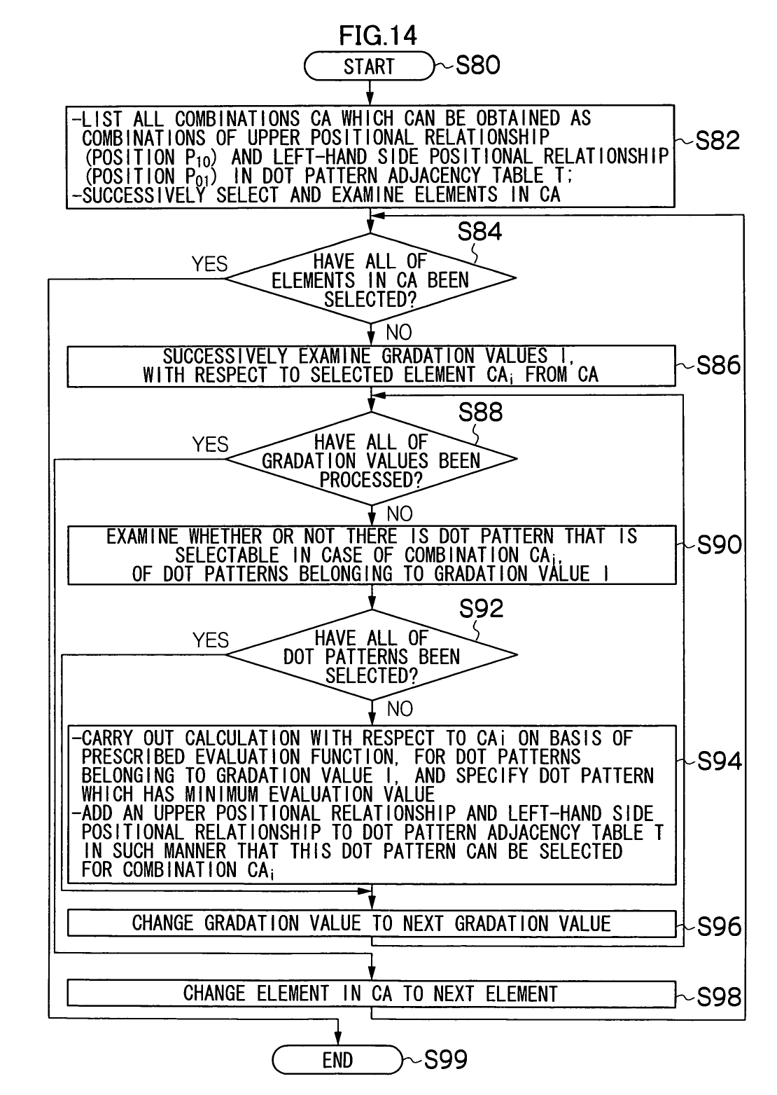

In order to avoid situations where there are no elements belonging to the group DA₁₁, a sequence for compensating and completing the dot pattern adjacency table (FIG. 14 described hereinafter) is carried out when creating the dot pattern adjacency table.

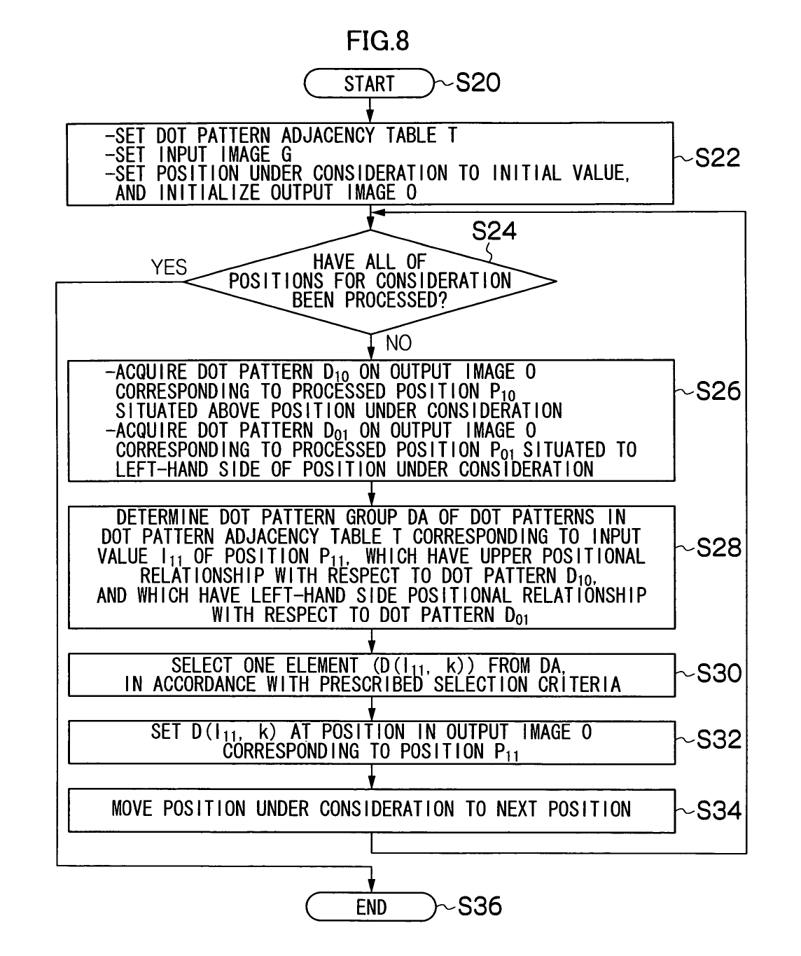

FIG. 8 is a flowchart showing the sequence of processing for creating a dot image. When the processing starts (step S20), firstly, the dot pattern adjacency table T is set in the initial processing step (step S22), and the input image G forming the original image to be processed is set. Furthermore, the position under consideration is set to an initial value and the output image O is initialized.

After this initial processing, the sequence proceeds to step S24, where it is judged whether or not there is a position for consideration. If there still remains an unprocessed pixel position, then there a position for consideration, and hence the procedure advances to step S26.

At step S26, the dot pattern D₁₀ on the output image O corresponding to the processed position P₁₀ situated above the position under consideration is acquired, and furthermore, the dot pattern D₀₁ on the output image O corresponding to the processed position P₀₁ situated to the left-hand side of the position under consideration is also acquired (see FIG. 5).

Thereupon, a group of dot patterns DA is found, by identifying those dot patterns of the dot patterns in the dot pattern adjacency table T corresponding to the input value (gradation value) I₁₁ of the position P₁₁, which have an upper side positional relationship with the dot pattern D₁₀ and have a left-hand side positional relationship with the dot pattern D₀₁ (step S28 in FIG. 8). The elements of the group DA are the dot pattern candidates for the position under consideration. Consequently, one element (D(I₁₁,k)) is selected from the group DA in accordance with prescribed selection criteria (step S30), and the selected dot pattern is set at the position in the output image O corresponding to the position P₁₁ (step S32).

At the start of processing, if there exist no processed pixels adjacent to the pixel under consideration, then a suitable processing approach is adopted, either by assuming that these pixels are the same as the pixel under consideration, or setting a prescribed fixed value (initial value), or the like.

After step S32, the position under consideration is moved to the next position, in accordance with the processing sequence shown in FIGS. 4 and 5 (step S34 in FIG. 8), and the procedure then returns to step S24.

The processing (for conversion to a dot pattern) is carried out for all of the pixel positions by repeating the processing in steps S24 to S34, and when the output image O has been completed, then at step S24, there is no subsequent position for consideration and hence this processing sequence terminates (step S36).

By carrying out digital halftoning using the image processing method according to the embodiment of the present invention, it is possible to obtain a dot image of high quality, by means of high-speed processing.

Description of Method for Creating Dot Pattern Adjacency Table

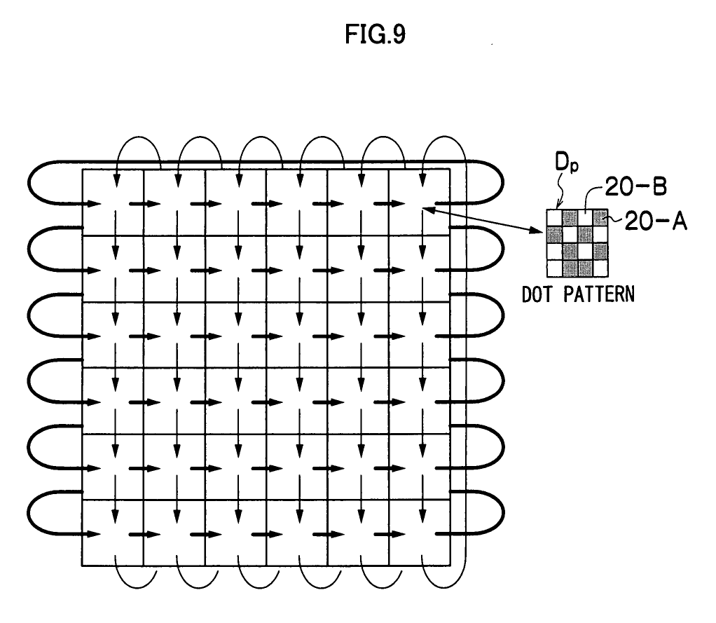

Next, the method of creating a dot pattern adjacency table is described. FIG. 9 is a conceptual diagram showing a state where a solid image (input image) of a certain density which has been converted into a dot image by means of satisfactory error diffusion processing (or blue noise mask processing), has then been divided up on the basis of a mesh used for the density pattern method (having the size of the pixel blocks which form the units for the dot patterns).

The dot image obtained by satisfactory error diffusion processing, or the like, reproduces a good image in overall terms, and therefore, good joins (relationships that produce no artifacts) are achieved between mutually adjacent dot patterns in the dot patterns of the respective areas divided up by the mesh of the prescribed size,. Furthermore, looking individually at the dot patterns in each area, the dot patterns are not all the same, but rather, a suitable variation (fluctuation) is observed in the patterns.

Consequently, by using the dot patterns for the respective areas in this dot image, and the information on the adjacency relationships, it is possible to obtain a combination of dot patterns having suitable adjacency relationships which present no problems of image quality.

More specifically, it is possible to set elements in the dot pattern adjacency table by gathering information on the adjacency relationships in upper and lower positions indicated by the thin arrows in FIG. 9, the adjacency relationships in left and right positions indicated by the thick arrows in FIG. 9, and the dot patterns of each of the areas.

By using the method described above to create dot images for a plurality of types of solid images of different density values and then divide up the images on the basis of a mesh, it is possible to acquire information for dot patterns having blue noise characteristics as shown in FIG. 9. Furthermore, besides using a solid image, it is also possible to use sample images which include edges or density variations, such as a gradated image, a natural image, or the like (namely, images having a variety of frequency components), as the input images. Prescribed satisfactory error diffusion processing, or the like, is carried out with respect to these various sample images, the dot images thus obtained are divided up according to the mesh size of the density pattern method, and information on the combinations of dot patterns having suitable adjacency relationships can then be obtained in relation to combinations of adjacent pixels having different input values.

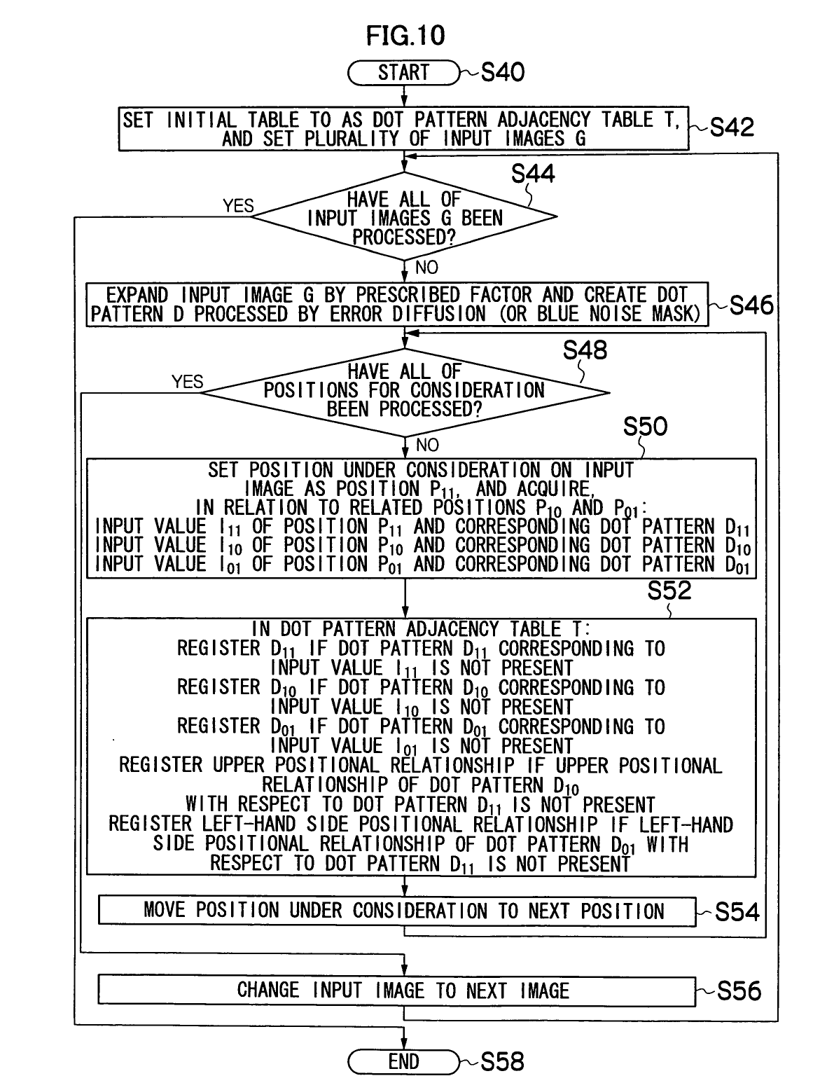

FIG. 10 is a flowchart showing a processing sequence in which information is added progressively to the dot pattern adjacency table. When this processing sequence is started (step S40), firstly, the initial table To is set as the dot pattern adjacency table T, and a plurality of types of input image G (corresponding to the aforementioned sample images) are set.

Thereupon, the procedure advances to step S44 and it is judged whether or not there is an input image G to be processed. If there remains an unprocessed input image G, then the procedure advances to step S46.

At step S46, one input image G is selected as the processing object, and after processing for expanding this one selected input image G at a prescribed rate of magnification, error diffusion processing (or blue noise mask processing) is carried out, thereby creating a dot pattern D (dot image).

This dot pattern D is then divided up into a prescribed pixel size, and thus split up into areas (pixel blocks) of equal number to the number of pixels in the input image G. The dot pattern Dᵢⱼ of each divided area is associated with the related pixel position (i, j) in the input image G. In other words, the dot pattern D is equivalent to a group of dot patterns Dᵢⱼ at the positions corresponding to the pixel positions (i, j) of the input image G.

Next, the procedure advances to step S48 and it is judged whether or not there is pixel (position for consideration) to be processed in the input image G. If there still remains an unprocessed pixel position, then a position for consideration exists, and hence the procedure advances to step S50.

At step S50, the position under consideration in the input image is taken to be the position P₁₁, and the input value I₁₁ of the position P₁₁ and the dot pattern D₁₁ corresponding to same, the input value I₁₀ of the position P₁₀ and the dot pattern D₁₀ corresponding to same, and the input value I₀₁ of the position P₀₁ and the dot pattern D₀₁ corresponding to same are acquired, in relation to the position P₁₀ which is adjacent on the upper side with respect to the position P₁₁, and the position P₀₁ which is adjacent on the left-hand side with respect to the position P₁₁ (see FIG. 5).

Thereupon, the procedure advances to step S52, and if the dot pattern D₁₁ corresponding to the input value I₁₁ is not present in the dot pattern adjacency table T, then D₁₁ is registered. Moreover, if the dot pattern D₁₀ corresponding to the input value I₁₀ is not present, then D₁₀ is registered. Further, if the dot pattern D₀₁ corresponding to the input value I₀₁ is not present, then D₀₁ is registered. Furthermore, if an upper positional relationship between the dot patterns D₁₁ and D₁₀ is not present in the table, then the upper positional relationship is registered, and if a left-hand side positional relationship between the dot patterns D₁₁ and D₀₁ is not present, then the left-hand side positional relationship is registered.

When the registration processing in step S52 has completed, the position under consideration is moved to the next position (step S54) and the procedure then returns to step S48.

When the processing for registering the dot patterns corresponding to all of the pixel positions on the input image has been completed by repeating the processing in the steps S48 to S54, there is no subsequent position for consideration at step S44, and hence the procedure advances to step S56.

In step S56, processing is carried out to change the input image forming the processing object, to the next image, and the procedure then returns to step S44.

When the aforementioned processing has been completed for all of the set types of input images G, by repeating the processing in steps S44 to S56, then at step S44, there is no subsequent input image and the present processing sequence is terminated (step S58).

By setting sample images of a plurality of types (images including various frequency components, besides a solid image), as an input image, and acquiring information relating to the dot patterns and the adjacency relationships by the method described in FIG. 10, it is possible to include dot patterns for a solid image having blue noise characteristics as shown in FIG. 9, as well as including dot patterns for satisfactorily processed non-solid images.

Consequently, according to the density pattern method according to the present embodiment which uses a dot pattern adjacency table generated by this method, it is possible to generate dot patterns of extremely high quality on a par with error diffusion processing or blue noise mask processing.

The processing sequence shown in FIG. 10 successively adds information relating to new adjacency relationships, thereby expanding the amount of information in the dot pattern adjacency table. The dot pattern adjacency table is consolidated by using a plurality of sample images to register dot patterns. However, the volume of data in the table progressively increases.

Therefore, desirably, the volume of data in the dot pattern adjacency table is restricted as far as possible while achieving a high-quality dot image of a level required in practical use (and more desirably, the data volume is kept to the required data volume).

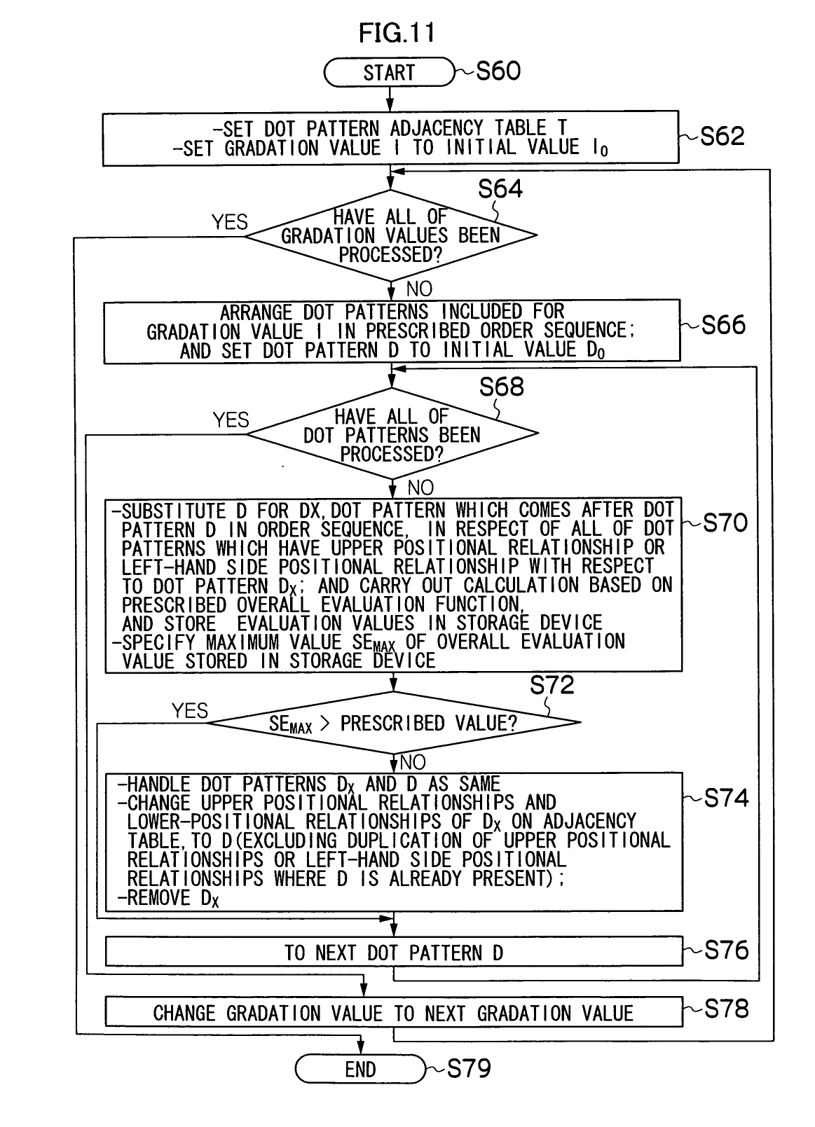

From this viewpoint, in the present embodiment, the table is slimmed down by unifying similar data in the dot pattern adjacency table by means of the processing sequence shown in FIG. 11 (namely, by eliminating redundant data).

FIG. 11 is a processing sequence which judges the similarity (interchangeability) of the dot patterns in the dot pattern adjacency table and eliminates data that is substantially redundant.

When this processing sequence starts (step S60), firstly, a dot pattern adjacency table T is established, and the gradation value I is set to an initial value I₀ (step S62).

Thereupon, the procedure advances to step S64 and it is judged whether or not there is a gradation value still to be processed. If there remains an unprocessed gradation value, then the procedure advances to step S66.

At step S66, processing is carried out for ordering the dot patterns included for the gradation value I into a prescribed sequence, and the dot pattern D is set to an initial value D₀ (the dot pattern at the head of the order sequence).

Thereupon, the procedure advances to step S68 and it is judged whether or not there is a dot pattern still to be processed. If there remains an unprocessed dot pattern, then the procedure advances to step S70.

At step S70, the currently set dot pattern D is substituted for the dot pattern Dₓ, which comes after dot pattern D in the order sequence, with respect to all of the dot patterns that have an upper position relationship or a left-hand side position relationship with the dot pattern Dₓ, and a calculation based on a prescribed overall evaluation function (described in detail below) is carried out. The resulting evaluation value (called the “overall evaluation value”) is stored in a storage device, such as a memory. The maximum value SE_{MAX} of the overall evaluation values stored in the storage device is found.

Next, it is judged whether or not this maximum value SE_{MAX} is greater than a prescribed value (a previously established judgment reference value) (step S72). If SE_{MAX} is equal to or lower than the prescribed value, then it is judged that there is no effect in terms of degradation of image quality caused by substituting Dₓ with D. The procedure then advances to step S74.

In other words, at step S74, processing is carried out in order that the dot patterns Dₓ and D are treated as the same pattern (namely, as redundant data having a relationship whereby they can be treated as substantially the same data). More specifically, the upper position relationships and the left-hand side position relationships relating to Dₓ on the dot pattern adjacency table are changed to D (excluding duplication of upper position relationships and left-hand side position relationships where D is already present), and Dₓ is removed from the table (step S74).

Subsequently, the dot pattern D is changed to the next (other) dot pattern (step S76), and the procedure then returns to step S68. In the judgment at step S72, if SE_{MAX} is greater than the prescribed value, then it is judged that substitution of D for Dₓ is not appropriate (namely, an effect is observed in terms of degradation of image quality caused by the substitution), and therefore Dₓ is left unaltered (the processing in step S74 is omitted). The procedure then advances to step S76.

When the processing for all of the dot patterns included in the gradation value I has been completed by repeating the processing in steps S68 to S76, then there is no unprocessed dot pattern at step S68, and hence the procedure advances to step S78.

At step S78, processing is carried out to change the gradation value I to the next gradation value, and the procedure then returns to step S64.

When the aforementioned processing has been completed for all of the gradation values, by repeating the processing in steps S64 to S78, then there is no unprocessed gradation value at step S64, and hence the present processing sequence terminates (step S79).

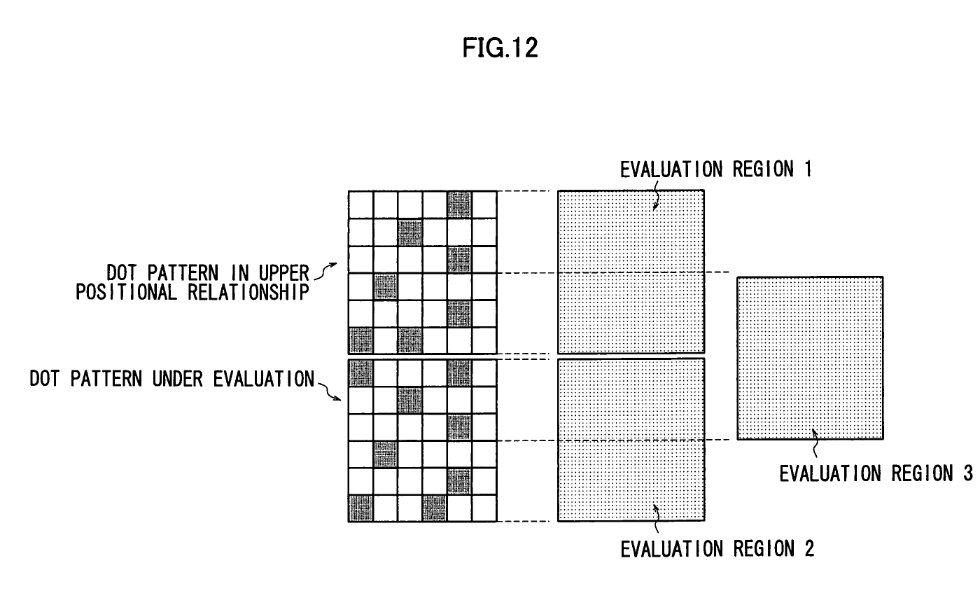

Here, an embodiment of the overall evaluation function is described. FIG. 12 is an illustrative diagram showing an embodiment of a method for evaluating mutually adjacent dot patterns. The description given here relates to a method of evaluating dot patterns which are adjacent in upper and lower positions, but evaluation can also be carried out by a similar method in respect of dot patterns which are adjacent in the left/right direction.

In FIG. 12, the dot pattern situated in the lower position, of the two dot patterns which are adjacent in upper and lower positions, is taken to be the “dot pattern under evaluation”. The dot pattern in the upper positional relationship with respect to this dot pattern under evaluation is called the “adjacent dot pattern”.

The evaluation regions 1 to 3 are defined as follows for these two dot patterns. “Evaluation region 1” is the whole region of the adjacent dot pattern. “Evaluation region 2” is the whole region of the dot pattern under evaluation. “Evaluation region 3” is a boundary region which covers both the adjacent dot pattern and the dot pattern under evaluation, and it includes a portion of the adjacent dot pattern (the lower half in FIG. 12) and a portion of the dot pattern under evaluation (the upper half in FIG. 12).

The characteristics values of the dot patterns are calculated with respect to the evaluation regions 1 to 3. The method used to calculate the characteristics values is a characteristics value calculation method proposed by Robert Ulichney, which includes the dispersion index (anisotropy) of a power spectrum based on radial coordinates which represents the distribution of dot brightness.

A generally known method for evaluating the dot pattern (dot arrangement) obtained as a result of digital halftoning is the method proposed by Robert Ulichney (“Digital Halftoning”, The MIT Press).

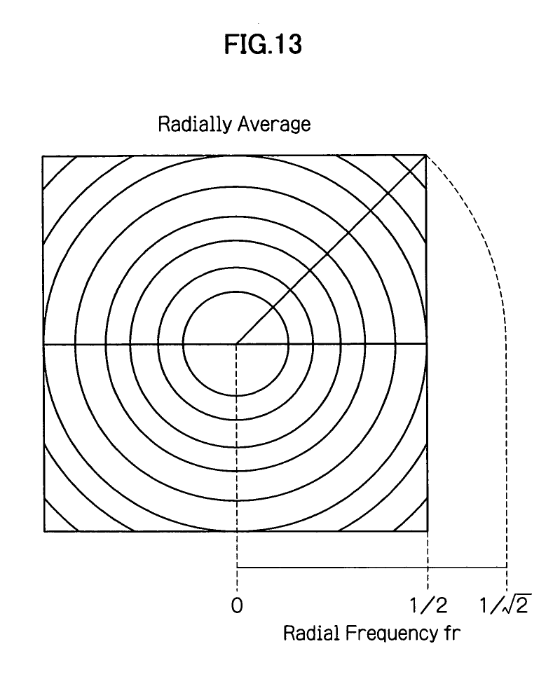

More specifically, the two-dimensional power spectrum of the dot placement is converted to radial coordinates, as in FIG. 13, and the index corresponding to the average and dispersion of the spectrum at all angles is calculated for the spatial frequency fr corresponding to the radius of the radial coordinates.

The average index of the polar-coordinate power spectrum is referred to as “radially averaged power spectrum (R.A.P.S.)” and is expressed by the following equation:

$${P}_{r} ( {f}_{r} ) = \frac{1}{{N}_{r} ( {f}_{r} )} {\sum }_{i = 1}^{{N}_{r} ( {f}_{r} )} {P}^{̑} ( f ) .$$

The dispersion index is referred to as “anisotropy” and is expressed by the following equation:

$${s}^{2} ( {f}_{r} ) = \frac{1}{{N}_{r} ( {f}_{r} ) - 1} {\sum }_{i = 1}^{{N}_{r} ( {f}_{r} )} {( {P}^{̑} ( f ) - {P}_{r} ( {f}_{r} ) )}^{2}$$

$$anisotropy = \frac{{s}^{2} ( {f}_{r} )}{{P}_{r}^{2} ( {f}_{r} )} .$$

The radially averaged power spectrum (R.A.P.S.) is a spectrum related to the visibility of the dot placement, and the anisotropy is the index pertaining to the anisotropy of the dot arrangement.

According to Robert Ulichney, the dot anisotropy ceases to be noticeable when the anisotropy is −10 decibels (dB) or less.

When a dot arrangement is evaluated using these indices, then a dot arrangement is said to have “blue noise characteristics” when it has characteristics where the R.A.P.S. is low in the low-frequency region, has a peak in the medium-frequency region, and is uniform in the high-frequency region, and the anisotropy is −10 decibels (dB) or less. When the dot arrangement specified by means of the threshold value matrix has blue noise characteristics, then that threshold value matrix is called a “blue noise mask”.

In the present embodiment, the characteristic values of the evaluation regions 1 to 3 (see FIG. 12) are calculated on the basis of a characteristics value calculation method which includes the Anisotropy index described above.

Taking the characteristics value of the evaluation region 1 (in other words, the characteristics value of the adjacent dot pattern) to be ED₁, the characteristics value of the evaluation region 2 when the dot pattern D is applied as the dot pattern under evaluation, to be ED₂, the characteristics value of the evaluation region 2 when the dot pattern Dₓ is used as the dot pattern under evaluation, to be EDₓ₂, the characteristics value of the evaluation region 3 when the dot pattern D is used as the dot pattern under evaluation, to be ED₃, and the characteristics value of the evaluation region 3 when the dot pattern Dₓ is used as the dot pattern under evaluation, to be EDₓ₃, the characteristics values 1 to 3 are defined as described below:

(Characteristics value 1)=EDₓ₃−ED₃;

(Characteristics value 2)=|ED₁−EDₓ₃−|ED₁−ED₃|; and

(Characteristics value 3)=|ED₂−EDₓ₃|−ED₂−ED₃|.

The characteristics value 1 expresses the difference in the boundary region dot pattern when the dot pattern is changed from the dot pattern D (or Dₓ) to the adjacent dot pattern. Furthermore, the characteristics value 2 and the characteristics value 3 represent the differences between the neighboring dot patterns D (or Dₓ) and the adjacent dot pattern.

The smaller the values of the characteristics values 1 to 3, the smaller the difference between the dot patterns D and Dₓ, and hence the smaller the effect on the image quality caused by substitution (namely, the higher the interchangeability).

The overall evaluation function described in step S70 in FIG. 11 includes at least one of the characteristics value 1, the characteristics value 2 and the characteristics value 3. Desirably, it includes all of the characteristics values 1 to 3. For example, the linear combination of the characteristics values 1 to 3 is used as the overall evaluation function.

Next, a sequence for compensating and completing the dot pattern adjacency table is described. When specifying a dot pattern for a position under consideration as shown in FIG. 5, in order to avoid a situation where there is no element (dot pattern candidate) which satisfies the conditions in the dot pattern adjacency table, the processing sequence shown in FIG. 14 is carried out when creating the dot pattern adjacency table.

When the processing in FIG. 14 starts (step S80), firstly, all of the combinations CA which can be obtained as a combination of an upper positional relationship (see the position P₁₀ in FIG. 5) and a left-hand side positional relationship (the position P₀₁) are listed in the dot pattern adjacency table T (step S82). The elements included in this group CA are then selected successively and are examined by means of the following processing.

At step S84, it is judged whether or not there is an element in CA that has not yet been selected. If there remains an unselected element, then the procedure advances to step S86, and an examination is made by the following processing, sequentially for each gradation value I, in respect of the element CAᵢ selected from CA.

At step S88, it is judged whether or not there is still a gradation value that has not yet been processed, and if there remains an unprocessed gradation value, then the procedure advances to step S90.

At step S90, it is investigated whether or not a dot pattern which belongs to the gradation value I that is being processed, and which can be selected in the case of the combination CAᵢ, is present in the dot pattern adjacency table. As a result of this, it is judged whether or not there is a selectable dot pattern in the table (step S92).

In the judgment in step S92, if it is judged that there is no selectable dot pattern, then a calculation based on the prescribed overall evaluation function is carried out with respect to the combination CAᵢ, for the dot patterns belonging to the gradation value I in question. The dot pattern having the smallest resulting evaluation value is specified. Information relating to an upper positional relationship and a left-hand side positional relationship are appended to the specified dot pattern, in such a manner that it can be selected for the combination CAᵢ, and the dot pattern is then added to the elements of the dot pattern adjacency table T (step S94).

An embodiment of the overall evaluation function used in step S94 is described below.

In evaluation region 3 shown in FIG. 12, the characteristics values 1′ to 3′ are defined as follows in a case where one of the dot patterns of the combination CAᵢ is taken to be a dot pattern in an upper positional relationship (or a left-hand side positional relationship), and the other dot pattern is taken to be the dot pattern under evaluation:

(Characteristics value 1′)=ED₃;

(Characteristics value 2′)=|ED₁−ED₃|; and

(Characteristics value 3′)=|ED₂−ED₃|,

where ED₁, ED₂ and ED₃ respectively express the characteristics value of the evaluation region 1, the characteristics value of the evaluation region 2 and the characteristics value of the evaluation region 3, shown in FIG. 12. Similarly to the embodiment described in step S70 in FIG. 11, the characteristics values ED₁, ED₂ and ED₃ of these respective evaluation regions 1 to 3 are calculated on the basis of a characteristics value calculation method which includes Anisotropy as an index of the anisotropy of the dot arrangement.

The prescribed overall evaluation function referred to at step S94 in FIG. 14 includes at least one of the characteristics value 1′, the characteristics value 2′ and the characteristics value 3′. Desirably, it includes all of the characteristics values 1′ to 3′. For example, the linear combination of the characteristics values 1′ to 3′ is used as the overall evaluation function.

After the processing in step S94, processing is carried out to change the gradation value I to the next gradation value (step S96), and the procedure then returns to step S88. In the judgment at step S92, if there is a selectable dot pattern, then it is not necessary to add a new element, and hence the processing in step S94 is omitted and the procedure advances to step S96.

When the aforementioned processing has been completed for all of the gradation values, by repeating the processing in steps S88 to S96, then at step S88, there is no unprocessed gradation value and the procedure advances to step S98.

At step S98, processing is carried out to change the element of the group CA to the next element, and the procedure then returns to step S84.

When the aforementioned processing has been completed for all of the elements in the group CA, by repeating the processing in steps S84 to S98, then at step S84, there is no CA element that has not yet been selected and the present processing sequence terminates (step S99).

By implementing this processing sequence, the dot pattern adjacency table T is made complete.

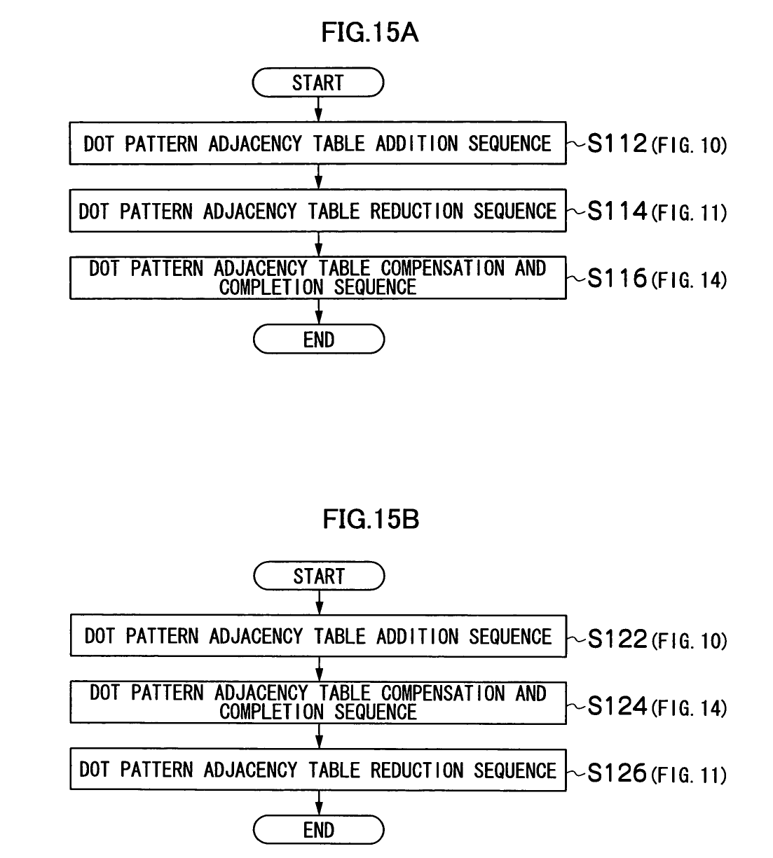

A dot pattern adjacency table is created by combining the implementation of the dot pattern adjacency table addition sequence shown in FIG. 10, the dot pattern adjacency table reduction sequence shown in FIG. 11, and the dot pattern adjacency table compensation and completion sequence shown in FIG. 14. The implementation sequence of the respective sequences may be “addition sequence” (step S112)→“reduction sequence” (step S114)→“compensation and completion sequence” (step S116), as shown in the embodiment in FIG. 15A, or it may be “addition sequence” (step S122)→“compensation and completion sequence” (step S124)→“reduction sequence” (step S126), as shown in the embodiment in FIG. 15B.

The method of creating the dot pattern adjacency table described above, and the image processing method for converting to a dot image by using this dot pattern adjacency table, can be achieved by means of a computer. More specifically, a program is created for causing a computer to implement the algorithms shown in FIGS. 8, 10, 11, 14, 15A and 15B, and by operating a computer by means of this program, it is possible to cause the computer to function as a dot pattern adjacency table creation apparatus or an image processing apparatus.

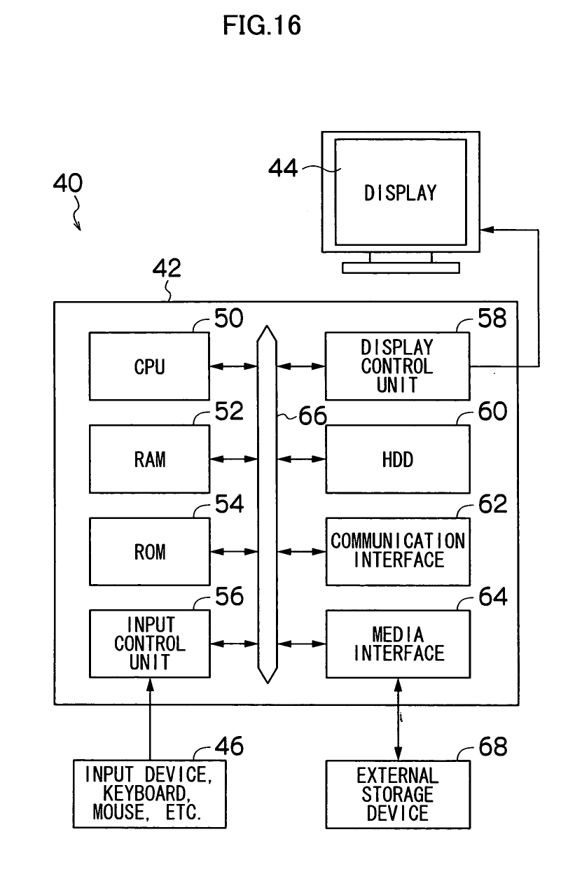

FIG. 16 is a block diagram showing an embodiment of the system composition of a computer. The computer 40 comprises a main body 42, a display (display device ) 44, and an input device 46 such as a keyboard and a mouse (input device for inputting various commands). The main body 42 houses a central processing unit (CPU) 50, a RAM 52, ROM 54, an input control unit 56 which controls the input of signals from the input apparatuses 46, a display control unit 58 which outputs display signals to the display 44, a hard disk device 60, a communication interface 62, a media interface 64, and the like, and these respective circuits are mutually connected by means of a bus 66.

The CPU 50 functions as a general control device and computing device. The RAM 52 is used as a temporary data storage region, and as a work area during execution of the program by the CPU 50. The ROM 54 is a rewriteable non-volatile storage device which stores a boot program for operating the CPU 50, various settings values and network connection information, and the like. An operating system (OS) and various applicational software programs and data, and the like, are stored in the hard disk apparatus 60.

The communication interface 62 is a device for connecting to an external device or communications network, on the basis of a prescribed communications system, such as USB, LAN, Bluetooth, or the like. The media interface 64 is a device which controls the reading and writing of the external storage device 68, which is typically a memory card, a magnetic disk, a magneto-optical disk, or an optical disk.

The program for creating the dot pattern adjacency table according to the embodiment of the present invention is stored in the hard disk device 60 or the external storage device 68, and the program is read out, developed in the RAM 52 and executed, according to requirements. Alternatively, it is also possible to adopt a mode in which a program is supplied by a server situated on a network (not shown) which is connected via the communication interface 62, or a mode in which a computation processing service based on the program is supplied by a server based on the Internet.

The operator is able to input various values required for calculation, by operating the input device 46 while observing the application window (not shown) displayed on the display 44, as well as being able to confirm the calculation results on the display 44.

FIG. 16 shows an embodiment in which the functions of an image processing apparatus and the functions of a dot pattern adjacency table creation apparatus are achieved by the computer 40, but a mode is also possible in which dedicated apparatuses provided with the image processing function according to the present invention and the dot pattern adjacency table creation function according to the present invention are composed.

Next, an embodiment of an image processing apparatus is described, in which a multiple-value image is converted into a dot image by using a dot pattern adjacency table created by the method described above.

Composition of Image Processing Apparatus

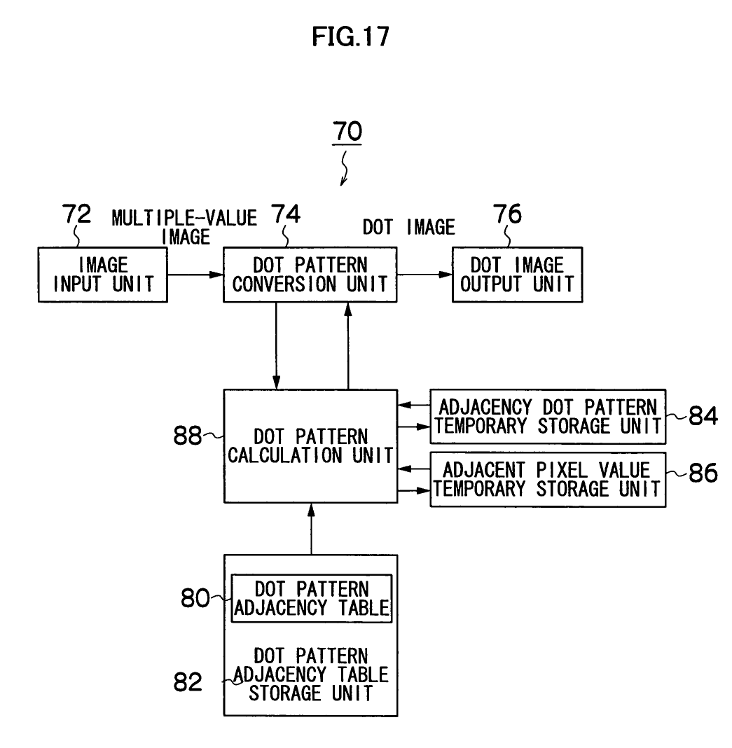

FIG. 17 is a block diagram showing the composition of an image processing apparatus according to an embodiment of the present invention. As described above, the image processing apparatus 70 according to the present embodiment comprises an image input unit 72, a dot pattern conversion unit 74, and a dot image output unit 76, as well as a storage unit (dot pattern adjacency table storage unit) 82 which stores the data of the dot pattern adjacency table 80, a storage unit 84 which temporarily stores adjacent dot patterns at processed positions adjacent to a position under consideration (an adjacent dot pattern temporary storage unit), a storage unit 86 which temporarily stores the pixel values (gradation values) of processed positions adjacent to a position under consideration (adjacent pixel value temporary storage unit), and a dot pattern calculation unit 88 which specifies the dot pattern for a position under consideration in the input image, by referring to the data in the respective storage units (82, 84, 86).

The image input unit 72 is an interface unit which inputs data of the original image (multiple-value digital image data) before halftoning (quantization processing). More specifically, this device may also be a communications interface, or a media interface for removable media, or a memory controller which acquires data from a memory, or the like.

The multiple-value image input from the image input unit 72 is converted into a binary dot image by the dot pattern conversion unit 74. In this, conversion processing is carried out using the dot pattern adjacency table 80. More specifically, the dot pattern conversion unit 74 and the dot pattern calculation unit 88 work conjointly to convert each pixel of the multiple-value image, successively, into a suitable dot pattern corresponding to the gradation value of the pixel. The specific processing sequence is as shown in FIG. 8.

For the dot pattern adjacency table storage unit 82 shown in FIG. 17, it is suitable to use, for example, a non-volatile memory such as an EEPROM, or a storage apparatus such as a hard disk apparatus. For the adjacent dot pattern temporary storage unit 84 and the adjacent pixel value temporary storage unit 86, it is suitable to use a volatile memory (RAM, or the like). It is possible to use separate memories (or storage apparatuses) respectively for the adjacent dot pattern temporary storage unit 84 and the adjacent pixel value temporary storage unit 86, and it is also possible to constitute the respective storage units (84, 86) by dividing up the storage regions of a single memory (or a storage apparatus).

The dot pattern D₁₀ corresponding to the processed position P₁₀ described in step S26 in FIG. 8, and the dot pattern D₀₁ corresponding to the processed position P₀₁, are stored in the adjacent dot pattern temporary storage unit 84, and information relating to the pixel values of the positions P₁₀ and P₀₁ is stored in the adjacent pixel value temporary storage unit 86 in FIG. 17.

The dot pattern calculation unit 88 specifies a suitable dot pattern for the position under consideration, by searching the dot pattern adjacency table 80 by means of a prescribed algorithm, on the basis of the information on the pixel value of the position under consideration in the input image acquired via the dot pattern conversion unit 74, the information on the adjacent dot patterns in the adjacent dot pattern temporary storage unit 84, and the information on the adjacent pixel values in the adjacent pixel value temporary storage unit 86.

The dot pattern conversion unit 74 successively carries out processing for incorporating the dot patterns specified by the dot pattern calculation unit 88 at the corresponding positions of the output image. When conversion to a dot pattern has been completed for all of the pixels, the dot image is complete.

The dot image output unit 76 corresponds to an output interface. Furthermore, if used in an image forming apparatus, the recording unit (image formation device) which actually records a dot image may correspond to this dot image output unit 76.

The processing functions in the dot pattern conversion unit 74, the dot pattern calculation unit 88, and the like, can be realized by means of software.

In the image processing apparatus according to the present embodiment, it is possible to achieve high-speed processing, and a high-quality dot image can be obtained.

Description of Inkjet Recording Apparatus Comprising the Image Processing Functions According to the Present Invention

Next, an embodiment of an inkjet recording apparatus equipped with the image processing functions described above is explained.

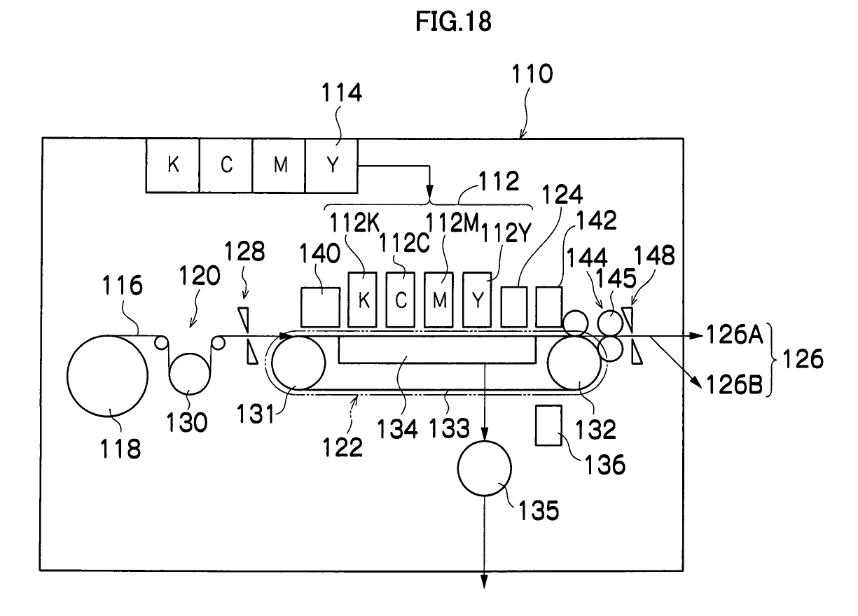

FIG. 18 is a general configuration diagram of an inkjet recording apparatus showing an embodiment of an image forming apparatus according to the present invention. As shown in FIG. 18, the inkjet recording apparatus 110 comprises: a printing unit 112 having a plurality of inkjet recording heads (hereafter, called “heads”) 112K, 112C, 112M, and 112Y provided for ink colors of black (K), cyan (C), magenta (M), and yellow (Y), respectively; an ink storing and loading unit 114 for storing inks of K, C, M and Y to be supplied to the heads 112K, 112C, 112M, and 112Y; a paper supply unit 118 for supplying recording paper 116 which is a recording medium; a decurling unit 120 removing curl in the recording paper 116; a belt conveyance unit 122 disposed facing the nozzle face (ink-droplet ejection face) of the printing unit 112, for conveying the recording paper 116 while keeping the recording paper 116 flat; a print determination unit 124 for reading the printed result produced by the printing unit 112; and a paper output unit 126 for outputting image-printed recording paper (printed matter) to the exterior.

The ink storing and loading unit 114 has ink tanks for storing the inks of K, C, M and Y to be supplied to the heads 112K, 112C, 112M, and 112Y, and the tanks are connected to the heads 112K, 112C, 112M, and 112Y by means of prescribed channels. The ink storing and loading unit 114 has a warning device (for example, a display device or an alarm sound generator) for warning when the remaining amount of any ink is low, and has a mechanism for preventing loading errors among the colors.

In FIG. 18, a magazine for rolled paper (continuous paper) is shown as an embodiment of the paper supply unit 118; however, more magazines with paper differences such as paper width and quality may be jointly provided. Moreover, papers may be supplied with cassettes that contain cut papers loaded in layers and that are used jointly or in lieu of the magazine for rolled paper.

In the case of a configuration in which a plurality of types of recording media can be used, it is preferable that an information recording medium such as a bar code and a wireless tag containing information about the type of medium is attached to the magazine, and by reading the information contained in the information recording medium with a predetermined reading device, the type of recording medium to be used is automatically determined, and ink-droplet ejection is controlled so that the ink-droplets are ejected in an appropriate manner in accordance with the type of medium.

The recording paper 116 delivered from the paper supply unit 118 retains curl due to having been loaded in the magazine. In order to remove the curl, heat is applied to the recording paper 116 in the decurling unit 120 by a heating drum 130 in the direction opposite from the curl direction in the magazine. The heating temperature at this time is preferably controlled so that the recording paper 116 has a curl in which the surface on which the print is to be made is slightly round outward.

In the case of the configuration in which roll paper is used, a cutter (first cutter) 128 is provided as shown in FIG. 18, and the roll paper is cut into a desired size by the cutter 128. When cut papers are used, the cutter 128 is not required.

The decurled and cut recording paper 116 is delivered to the belt conveyance unit 122. The belt conveyance unit 122 has a configuration in which an endless belt 133 is set around rollers 131 and 132 so that the portion of the endless belt 133 facing at least the nozzle face of the printing unit 112 and the sensor face of the print determination unit 124 forms a horizontal plane (flat plane).

The belt 133 has a width that is greater than the width of the recording paper 116, and a plurality of suction apertures (not shown) are formed on the belt surface. A suction chamber 134 is disposed in a position facing the sensor surface of the print determination unit 124 and the nozzle surface of the printing unit 112 on the interior side of the belt 133, which is set around the rollers 131 and 132, as shown in FIG. 18. The suction chamber 134 provides suction with a fan 135 to generate a negative pressure, and the recording paper 116 is held on the belt 133 by suction. In place of the suction system, the electrostatic attraction system can be employed.

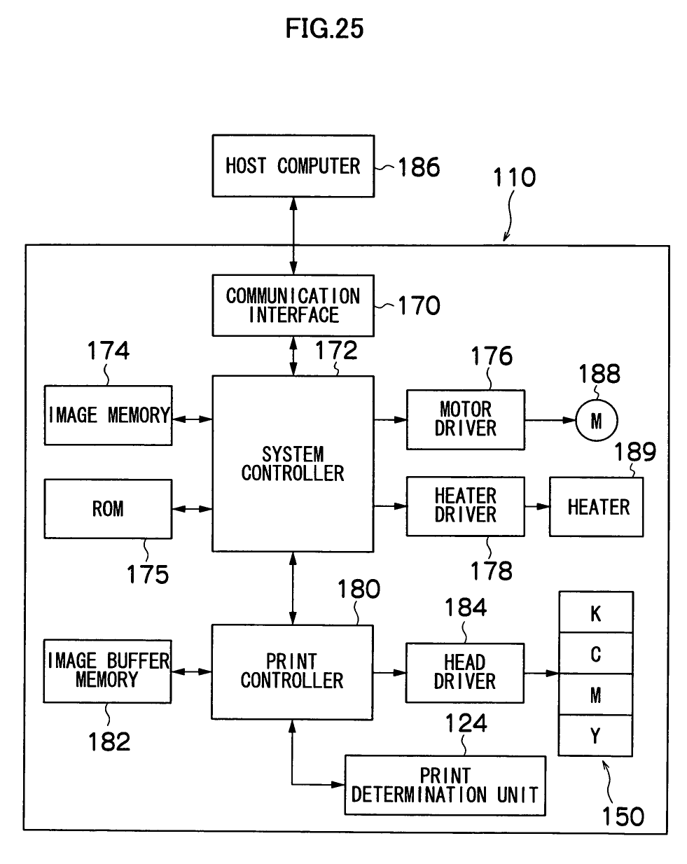

The belt 133 is driven in the clockwise direction in FIG. 18 by the motive force of a motor 188 (shown in FIG. 25) being transmitted to at least one of the rollers 131 and 132, which the belt 133 is set around, and the recording paper 116 held on the belt 133 is conveyed from left to right in FIG. 18.

Since ink adheres to the belt 133 when a marginless print job or the like is performed, a belt-cleaning unit 136 is disposed in a predetermined position (a suitable position outside the printing area) on the exterior side of the belt 133. Although the details of the configuration of the belt-cleaning unit 136 are not shown, embodiments thereof include a configuration in which the belt 133 is nipped with cleaning rollers such as a brush roller and a water absorbent roller, an air blow configuration in which clean air is blown onto the belt 133, or a combination of these. In the case of the configuration in which the belt 133 is nipped with the cleaning rollers, it is preferable to make the line velocity of the cleaning rollers different than that of the belt 133 to improve the cleaning effect.

The inkjet recording apparatus 110 can comprise a roller nip conveyance mechanism, in which the recording paper 116 is pinched and conveyed with nip rollers, instead of the belt conveyance unit 122. However, there is a drawback in the roller nip conveyance mechanism that the print tends to be smeared when the printing area is conveyed by the roller nip action because the nip roller makes contact with the printed surface of the paper immediately after printing. Therefore, the suction belt conveyance in which nothing comes into contact with the image surface in the printing area is preferable.

A heating fan 140 is disposed on the upstream side of the printing unit 112 in the conveyance pathway formed by the belt conveyance unit 122. The heating fan 140 blows heated air onto the recording paper 116 to heat the recording paper 116 immediately before printing so that the ink deposited on the recording paper 116 dries more easily.

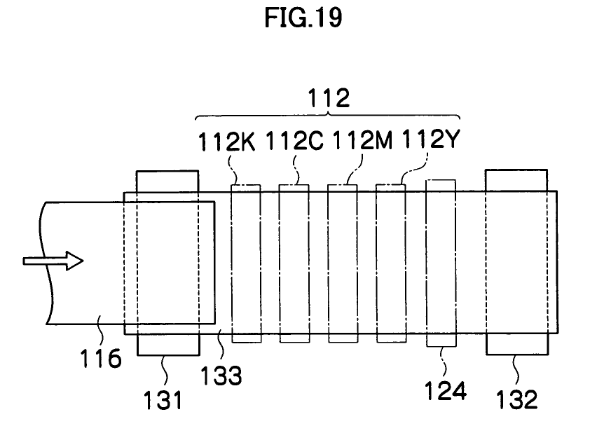

The heads 112K, 112C, 112M and 112Y of the printing unit 112 are full line heads having a length corresponding to the maximum width of the recording paper 116 used with the inkjet recording apparatus 110, and comprising a plurality of nozzles for ejecting ink arranged on a nozzle face through a length exceeding at least one edge of the maximum-size recording medium (namely, the full width of the printable range) (see FIG. 19).

The heads 112K, 112C, 112M and 112Y are arranged in color order (black (K), cyan (C), magenta (M), yellow (Y)) from the upstream side in the feed direction of the recording paper 116, and these respective heads 112K, 112C, 112M and 112Y are fixed extending in a direction substantially perpendicular to the conveyance direction of the recording paper 116.

A color image can be formed on the recording paper 116 by ejecting inks of different colors from the heads 112K, 112C, 112M and 112Y, respectively, onto the recording paper 116 while the recording paper 116 is conveyed by the belt conveyance unit 122.

By adopting a configuration in which the full line heads 112K, 112C, 112M and 112Y having nozzle rows covering the full paper width are provided for the respective colors in this way, it is possible to record an image on the full surface of the recording paper 116 by performing just one operation of relatively moving the recording paper 116 and the printing unit 112 in the paper conveyance direction (the sub-scanning direction), in other words, by means of a single sub-scanning action. Higher-speed printing is thereby made possible and productivity can be improved in comparison with a shuttle type head configuration in which a recording head reciprocates in the main scanning direction.

Although the configuration with the KCMY four standard colors is described in the present embodiment, combinations of the ink colors and the number of colors are not limited to those. Light inks, dark inks or special color inks can be added as required. For example, a configuration is possible in which inkjet heads for ejecting light-colored inks such as light cyan and light magenta are added. Furthermore, there are no particular restrictions of the sequence in which the heads of respective colors are arranged.

The print determination unit 124 illustrated in FIG. 18 has an image sensor (line sensor or area sensor) for capturing an image of the droplet ejection result of the print unit 112, and functions as a device which measures the dependency relationships between dots and the dot displacement amounts, on the basis of the image of ejected droplets read in by the image sensor, as well as functioning as a device which checks for ejection defects, such as blockages, landing position displacement, and the like, of the nozzles. A test pattern or the target image printed by the heads 112K, 112C, 112M, and 112Y of the respective colors is read in by the print determination unit 124, and the ejection performed by each head and the dependency relationships in each head are determined. The ejection determination includes the presence of the ejection, measurement of the dot size, and measurement of the dot landing position.

A post-drying unit 142 is disposed following the print determination unit 124. The post-drying unit 142 is a device to dry the printed image surface, and includes a heating fan, for example. It is preferable to avoid contact with the printed surface until the printed ink dries, and a device that blows heated air onto the printed surface is preferable.

In cases in which printing is performed with dye-based ink on porous paper, blocking the pores of the paper by the application of pressure prevents the ink from coming contact with ozone and other substance that cause dye molecules to break down, and has the effect of increasing the durability of the print.

A heating/pressurizing unit 144 is disposed following the post-drying unit 142. The heating/pressurizing unit 144 is a device to control the glossiness of the image surface, and the image surface is pressed with a pressure roller 145 having a predetermined uneven surface shape while the image surface is heated, and the uneven shape is transferred to the image surface.

The printed matter generated in this manner is outputted from the paper output unit 126. The target print (i.e., the result of printing the target image) and the test print are preferably outputted separately. In the inkjet recording apparatus 110, a sorting device (not shown) is provided for switching the outputting pathways in order to sort the printed matter with the target print and the printed matter with the test print, and to send them to paper output units 126A and 126B, respectively. When the target print and the test print are simultaneously formed in parallel on the same large sheet of paper, the test print portion is cut and separated by a cutter (second cutter) 148. Although not shown in FIG. 18, the paper output unit 126A for the target prints is provided with a sorter for collecting prints according to print orders.

Composition of Head

Next, the structure of a head is described. The heads 112K, 112C, 112M and 112Y of the respective ink colors have the same structure, and a reference numeral 150 is hereinafter designated to any of the heads.

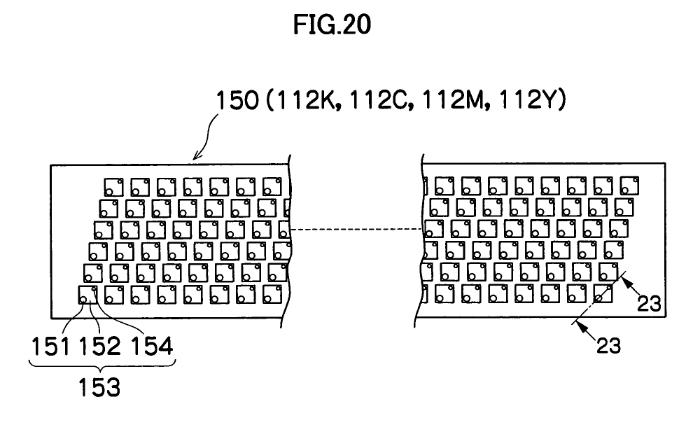

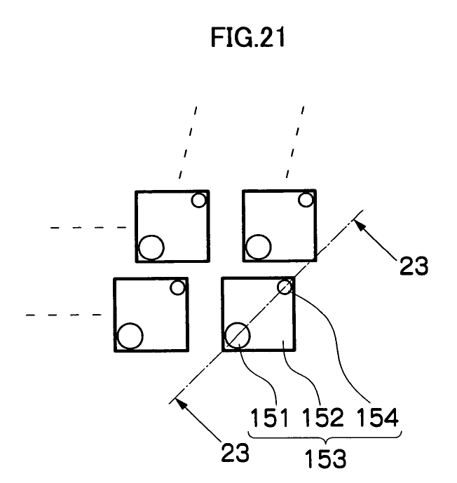

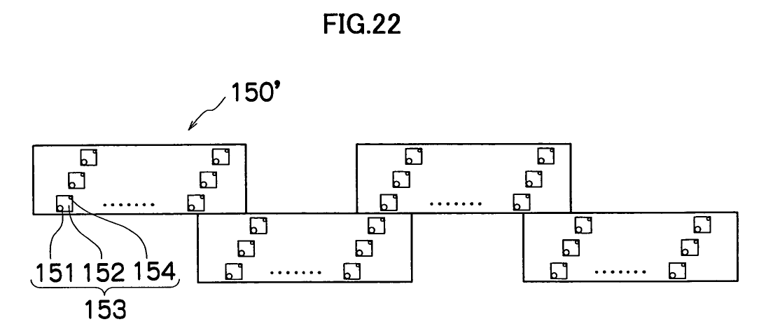

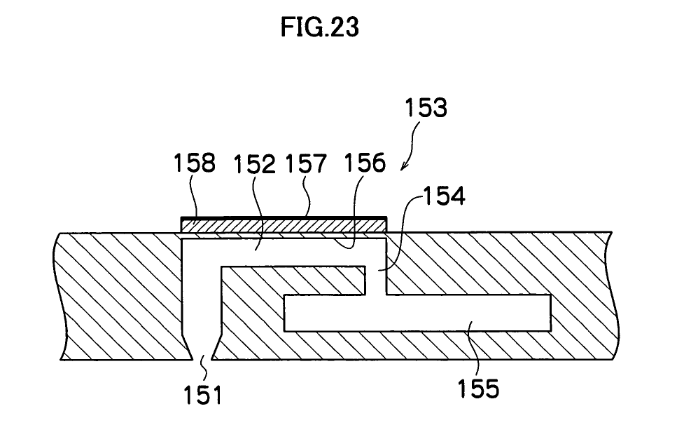

FIG. 20 is a perspective plan view showing an embodiment of the configuration of the head 150, FIG. 21 is an enlarged view of a portion thereof, FIG. 22 is a perspective plan view showing another embodiment of the configuration of the head 150, and FIG. 23 is a cross-sectional view taken along the line 23-23 in FIGS. 20, showing a three-dimensional composition of one droplet ejection element (an ink chamber unit for one nozzle 151).

The nozzle pitch in the head 150 should be minimized in order to maximize the density of the dots printed on the surface of the recording paper 116. As shown in FIGS. 20 and 21, the head 150 according to the present embodiment has a structure in which a plurality of ink chamber units (droplet ejection elements) 153, each comprising a nozzle 151 forming an ink ejection port, a pressure chamber 152 corresponding to the nozzle 151, and the like, are disposed two-dimensionally in the form of a staggered matrix, and hence the effective nozzle interval (the projected nozzle pitch) as projected in the lengthwise direction of the head (the direction perpendicular to the paper conveyance direction) is reduced and high nozzle density is achieved.

The mode of forming one or more nozzle rows through a length corresponding to the entire width of the recording paper 116 in a direction substantially orthogonal to the conveyance direction of the recording paper 116 is not limited to the embodiment described here. For example, instead of the composition in FIG. 20, as shown in FIG. 22, a line head having nozzle rows of a length corresponding to the entire width of the recording paper 116 can be formed by arranging and combining, in a staggered matrix, short head modules 150′ each having a plurality of nozzles 151 arrayed in a two-dimensional fashion.

As shown in FIGS. 20 and 21, the planar shape of the pressure chamber 152 provided corresponding to each nozzle 151 is substantially a square shape, and an outlet port to the nozzle 151 is provided at one of the ends of the diagonal line of the planar shape, while an inlet port (supply port) 154 for supplying ink is provided at the other end thereof. The shape of the pressure chamber 152 is not limited to that of the present embodiment and various modes are possible in which the planar shape is a quadrilateral shape (diamond shape, rectangular shape, or the like), a pentagonal shape, a hexagonal shape, or other polygonal shape, or a circular shape, elliptical shape, or the like.

As shown in FIG. 23, each pressure chamber 152 is connected to a common channel 155 through the supply port 154. The common channel 155 is connected to an ink tank (not shown), which is a base tank that supplies ink, and the ink supplied from the ink tank is delivered through the common flow channel 155 to the pressure chambers 152.

An actuator 158 provided with an individual electrode 157 is bonded to a pressure plate (a diaphragm that also serves as a common electrode) 156 which forms the surface of one portion (in FIG. 23, the ceiling) of the pressure chambers 152. When a drive voltage is applied to the individual electrode 157 and the common electrode, the actuator 158 deforms, thereby changing the volume of the pressure chamber 152. This causes a pressure change which results in ink being ejected from the nozzle 151. For the actuator 158, it is possible to adopt a piezoelectric element using a piezoelectric body, such as lead zirconate titanate, barium titanate, or the like. When the displacement of the actuator 158 returns to its original position after ejecting ink, the pressure chamber 152 is filled with new ink from the common flow channel 155, via the supply port 154.

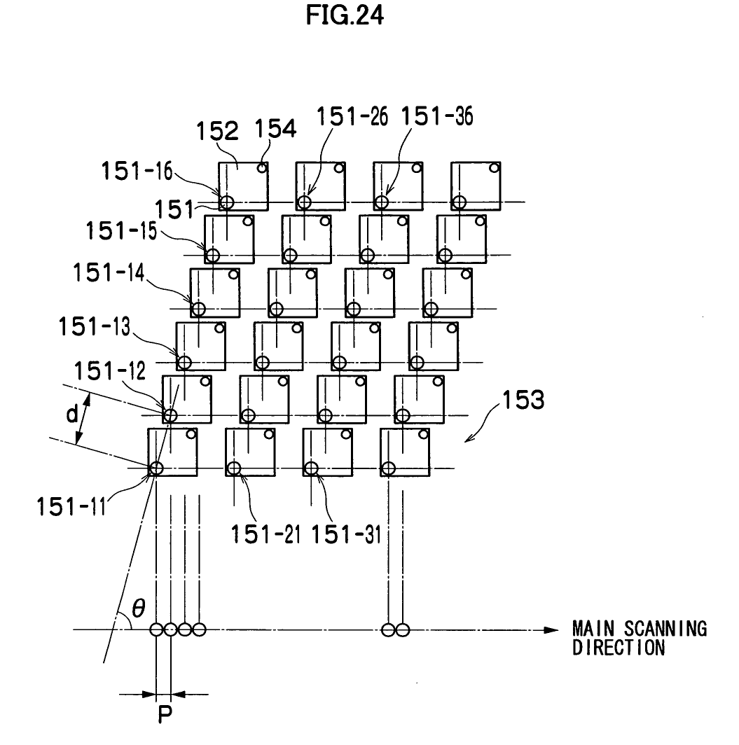

As shown in FIG. 24, the high-density nozzle head according to the present embodiment is achieved by arranging a plurality of ink chamber units 153 having the above-described structure in a lattice fashion based on a fixed arrangement pattern, in a row direction which coincides with the main scanning direction, and a column direction which is inclined at a fixed angle of 0 with respect to the main scanning direction, rather than being perpendicular to the main scanning direction.

More specifically, by adopting a structure in which a plurality of ink chamber units 153 are arranged at a uniform pitch d in line with a direction forming an angle of θ with respect to the main scanning direction, the pitch P of the nozzles projected so as to align in the main scanning direction is d×cos θ, and hence the nozzles 151 can be regarded to be equivalent to those arranged linearly at a fixed pitch P along the main scanning direction. Such configuration results in a nozzle structure in which the nozzle row projected in the main scanning direction has a high nozzle density of up to 2,400 nozzles per inch.

In a full-line head comprising rows of nozzles that have a length corresponding to the entire width of the image recordable width, the “main scanning” is defined as printing one line (a line formed of a row of dots, or a line formed of a plurality of rows of dots) in the width direction of the recording paper (the direction perpendicular to the conveyance direction of the recording paper) by driving the nozzles in one of the following ways: (1) simultaneously driving all the nozzles; (2) sequentially driving the nozzles from one side toward the other; and (3) dividing the nozzles into blocks and sequentially driving the nozzles from one side toward the other in each of the blocks.

In particular, when the nozzles 151 arranged in a matrix such as that shown in FIG. 24 are driven, the main scanning according to the above-described (3) is preferred. More specifically, the nozzles 151-11, 151-12, 151-13, 151-14, 151-15 and 151-16 are treated as a block (additionally; the nozzles 151-21, 151-22, . . . , 151-26 are treated as another block; the nozzles 151-31, 151-32, . . . , 151-36 are treated as another block; . . . ); and one line is printed in the width direction of the recording paper 116 by sequentially driving the nozzles 151-11, 151-12, . . . , 151-16 in accordance with the conveyance velocity of the recording paper 116.

On the other hand, “sub-scanning” is defined as to repeatedly perform printing of one line (a line formed of a row of dots, or a line formed of a plurality of rows of dots) formed by the main scanning, while moving the full-line head and the recording paper relative to each other.

The direction indicated by one line (or the lengthwise direction of a band-shaped region) recorded by main scanning as described above is called the “main scanning direction”, and the direction in which sub-scanning is performed, is called the “sub-scanning direction”. In other words, in the present embodiment, the conveyance direction of the recording paper 116 is called the sub-scanning direction and the direction perpendicular to same is called the main scanning direction.

In implementing the present invention, the arrangement of the nozzles is not limited to that of the embodiment illustrated. Moreover, a method is employed in the present embodiment where an ink droplet is ejected by means of the deformation of the actuator 158, which is typically a piezo element (piezoelectric element); however, in implementing the present invention, the method used for discharging ink is not limited in particular, and instead of the piezo jet method, it is also possible to apply various types of methods, such as a thermal jet method where the ink is heated and bubbles are caused to form therein by means of a heat generating body such as a heater, ink droplets being ejected by means of the pressure applied by these bubbles.

Description of Control System

FIG. 25 is a block diagram showing the system configuration of the inkjet recording apparatus 110. As shown in FIG. 25, the inkjet recording apparatus 110 comprises a communication interface 170, a system controller 172, an image memory 174, a ROM 175, a motor driver 176, a heater driver 178, a print controller 180, an image buffer memory 182, a head driver 184, and the like.

The communication interface 170 (corresponding to an image input device) is an interface unit for receiving image data sent from a host computer 186. A serial interface such as USB, IEEE1394, Ethernet, wireless network, or a parallel interface such as a Centronics interface may be used as the communication interface 170. A buffer memory (not shown) may be mounted in this portion in order to increase the communication speed.

The image data sent from the host computer 186 is received by the inkjet recording apparatus 110 through the communication interface 170, and is temporarily stored in the image memory 174. The image memory 174 is a storage device for storing images inputted through the communication interface 170, and data is written and read to and from the image memory 174 through the system controller 172. The image memory 174 is not limited to a memory composed of semiconductor elements, and a hard disk drive or another magnetic medium may be used.

The system controller 172 is constituted by a central processing unit (CPU) and peripheral circuits thereof, and the like, and it functions as a control device for controlling the whole of the inkjet recording apparatus 110 in accordance with a prescribed program, as well as a calculation device for performing various calculations. More specifically, the system controller 172 controls the various sections, such as the communication interface 170, image memory 174, motor driver 176, heater driver 178, and the like, as well as controlling communications with the host computer 186 and writing and reading to and from the image memory 174 and ROM 175, and it also generates control signals for controlling the motor 188 and heater 189 of the conveyance system.

The program executed by the CPU of the system controller 172 and the various types of data which are required for control procedures are stored in the ROM 175. Furthermore, the dot pattern adjacency table used in the halftoning process is also stored in this ROM 175. The ROM 175 may be a non-writeable storage device, or it may be a rewriteable storage device, such as an EEPROM. The image memory 174 is used as a temporary storage region for the image data, and it is also used as a program development region and a calculation work region for the CPU.

The motor driver (drive circuit) 176 drives the motor 188 of the conveyance system in accordance with commands from the system controller 172. The heater driver (drive circuit) 178 drives the heater 189 of the post-drying unit 142 or the like in accordance with commands from the system controller 172.

The print controller 180 is a control unit which functions as a signal processing device for performing various treatment processes, corrections, and the like, in accordance with the control implemented by the system controller 172, in order to generate a signal for controlling printing from the image data (multiple-value input image data) in the image memory 174, as well as functioning as a drive control device (recording control device) which controls the ejection driving of the head 150 by supplying the ink ejection data thus generated to the head driver 184.

In other words, the print controller 180 comprises a device for carrying out signal processing in order to generate density data for the respective ink colors from the data of the input image (density conversion processing including UCR processing and color conversion, and where necessary, resolution conversion processing), as well as a halftoning device which converts the density data thus obtained for each color into binary ink (coloring material) dot data. The ink ejection data generated by the print controller 180 is supplied to the head driver 184, which controls the ink ejection operation of the head 150 accordingly.

The print controller 180 is provided with the image buffer memory 182; and image data, parameters, and other data are temporarily stored in the image buffer memory 182 when image data is processed in the print controller 180. The aspect shown in FIG. 25 is one in which the image buffer memory 182 accompanies the print controller 180; however, the image memory 174 may also serve as the image buffer memory 182. Also possible is an aspect in which the print controller 180 and the system controller 172 are integrated to form a single processor.

To give a general description of the sequence of processing from image input to print output, image data to be printed (original image data) is input from an external source via a communications interface 170, and is accumulated in the image memory 174. At this stage, RGB image data is stored in the image memory 174, for example.

In this inkjet recording apparatus 110, an image which appears to have a continuous tonal graduation to the human eye is formed by changing the droplet ejection density and the dot size of fine dots created by ink (coloring material), and therefore, it is necessary to convert the input digital image into a dot pattern which reproduces the tonal gradations of the image (namely, the light and shade toning of the image) as faithfully as possible. Therefore, original image data (RGB data) stored in the image memory 174 is sent to the print controller 180 through the system controller 172, and is converted into dot data for each ink color by a half-toning technique in the print controller 180.

In other words, the print controller 180 performs processing for converting the input RGB image data into dot data for the four colors of K, C, M and Y. In the present embodiment, the image is converted into dot images for each respective color, by means of the processing sequence shown in FIG. 8. The dot image data generated by the print controller 180 in this way is stored in the image buffer memory 182. This dot data is converted into CMYK droplet ejection data for ejecting ink from the nozzles of the head 150, thereby establishing the ink ejection data to be printed.

The head driver 184 outputs a drive signal for driving the actuators 158 corresponding to the nozzles 151 of the head 150 in accordance with the print contents, on the basis of the ink ejection data and the drive waveform signals supplied by the print controller 180. A feedback control system for maintaining constant drive conditions in the head may be included in the head driver 184.

By supplying the drive signal output by the head driver 184 to the head 150 in this way, ink is ejected from the corresponding nozzles 151. By controlling ink ejection from the head 150 in synchronization with the conveyance speed of the recording paper 116, an image is formed on the recording paper 116.

As described above, the ejection volume and the ejection timing of the ink droplets from the respective nozzles are controlled via the head driver 184, on the basis of the ink ejection data generated by implementing prescribed signal processing in the print controller 180, and the drive signal waveform. Accordingly, a desired image can be recorded onto the recording paper 116.

As shown in FIG. 18, the print determination unit 124 is a block including an image sensor, which reads in the image printed onto the recording medium 116, performs various signal processing operations, and the like, and determines the print situation (presence/absence of ejection, variation in droplet ejection, optical density, and the like), these determination results being supplied to the print controller 180. Instead of or in conjunction with this print determination unit 124, it is also possible to provide another ejection determination device (corresponding to an ejection abnormality determination device).

As a further ejection determination device, it is possible to adopt, for example, a mode (internal determination method) in which a pressure sensor is provided inside or in the vicinity of each pressure chamber 152 of the head 150, and ejection abnormalities are determined from the determination signals obtained from these pressure sensors when ink is ejected or when the actuators are driven in order to measure the pressure. Alternatively, it is also possible to adopt a mode (external determination method) using an optical determination system comprising a light source, such as a laser light emitting element, and a photoreceptor element, whereby light, such as laser light, is irradiated onto the ink droplets ejected from the nozzles and the droplets in flight are determined by means of the transmitted light quantity (received light quantity).

The print controller 180 shown in FIG. 25 implements various corrections with respect to the head 150, on the basis of the information obtained from the print determination unit 124 or another ejection determination device (not illustrated), according to requirements, and it implements control for carrying out cleaning operations (nozzle restoring operations), such as preliminary ejection, suctioning, or wiping, as and when necessary.

In the case of the present embodiment, the system controller 172 or the print controller 180, or a combination of the system controller 172 and the print controller 180 function as the “dot pattern conversion processing device” and the “dot pattern specifying device” of the present invention, as well as functioning as a “recording control device” which controls droplet ejection on the basis of the results of halftoning processing.

According to the inkjet recording apparatus 110 having the composition described above, it is possible to form images of high quality at high speed.

The description given above relates to an embodiment in which processing for converting to a dot image is carried out in the inkjet recording apparatus 110, but also possible is a mode in which all or a portion of the dot image generation and processing functions carried out by the print controller 180 in the foregoing description are provided in the host computer 186.

Furthermore, in the present embodiment, an inkjet recording apparatus having a full line type head is described, but the scope of application of the present invention is not limited to this. For example, the present invention may also be applied to a case where images are formed by using a head of a length which is shorter than the width dimension of the recording medium (the recording paper 116 or other print media), and scanning the head a plurality of times, as in a shuttle scanning method.

In the foregoing embodiments, the inkjet recording apparatus is described as one embodiment of the image forming apparatus, but the range of application of the present invention is not limited to this. The present invention can also be applied to image forming apparatuses based on various types of methods other than an inkjet method, such as a thermal transfer recording apparatus using a line head (an apparatus using thermal elements as recording elements), an LED (light-emitting diode) electrophotographic printer, a silver halide photographic type printer having an LED line exposure head (an apparatus using LED elements as recording elements), or the like.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. An image processing method which converts an input image in which multiple-value gradation values are assigned to pixels, into a dot image, by performing processing for converting each of the pixels of the input image into a dot pattern of a pixel block composed of a plurality of binary pixels,
wherein the dot pattern of a pixel under consideration is specified according to the gradation value of the pixel under consideration in the input image, the gradation values of at least two processed adjacent pixels that are adjacent to the pixel under consideration, and the dot patterns of the at least two processed adjacent pixels.

2. The image processing method as defined in claim 1, wherein processing for converting into the dot patterns is carried out successively while moving the pixel under consideration in a prescribed scanning direction and processing sequence in the input image.

3. The image processing method as defined in claim 1, wherein resolution of the input image and resolution of the dot image have a resolution ratio relationship which corresponds to a size of the dot patterns.

4. The image processing method as defined in claim 1, wherein at least one dot pattern is prepared in advance for each of the gradation values, and the dot pattern for the pixel under consideration is specified from the dot patterns by using a dot pattern adjacency table which defines adjacency relationships between dot patterns that are capable of being arranged in mutually adjacent positions on the dot image.

5. The image processing method as defined in claim 1, wherein the two processed adjacent pixels are an upper side adjacent pixel positioned in an upward direction from the pixel under consideration, and a left-hand side adjacent pixel positioned in a leftward direction from the pixel under consideration, in a pixel arrangement plane of the input image.

6. An image processing apparatus, comprising:
an image input device which captures an input image in which multiple-value gradation values are assigned to pixels;
a dot pattern conversion processing device which carries out processing for converting each of the pixels of the input image into a dot pattern of a pixel block composed of a plurality of binary pixels, the dot pattern conversion processing device including a dot pattern specifying device which specifies the dot pattern of the pixel under consideration according to the gradation value of the pixel under consideration in the input image, the gradation values of at least two processed adjacent pixels that are adjacent to the pixel under consideration, and the dot patterns of the at least two processed adjacent pixels; and
a dot image output device which outputs a dot image obtained by means of processing performed by the dot pattern conversion processing device.

7. The image processing apparatus as defined in claim 6, wherein:
the dot pattern specifying device has a dot pattern adjacency table which defines the dot patterns usable for each of the gradation values, and adjacency relationships allowable between the dot patterns; and
the dot pattern for the pixel under consideration is specified by using the dot pattern adjacency table.

8. The image processing apparatus as defined in claim 6, further comprising a storage device which stores a relative positional relationship with a position of the pixel under consideration, in an association with the dot patterns.

9. An image forming apparatus, comprising:
the image processing apparatus as defined in claim 6;
a recording head in which a plurality of recording elements are arranged;
a conveyance device which causes the recording head and a recording medium to move relatively to each other by conveying at least one of the recording head and the recording medium; and
a recording control device which controls driving of the recording elements according to dot image data obtained by processing of the image processing apparatus.

10. A computer readable medium having embodied thereon an image processing program for performing by a computer, the image processing program causing the computer to function as the image processing apparatus as defined in claim 6.

11. A method of creating a dot pattern adjacency table, comprising:
a pattern generation step of generating dot patterns of a pixel block composed of a plurality of binary pixels, which represent a tonal gradation corresponding to a multiple-value gradation value;
an adjacency relationship acquisition step of acquiring information indicating adjacency relationships between dot patterns that are capable of being arranged in mutually adjacent positions; and
a registration step of registering the information indicating the adjacency relationships, and the dot patterns, in association with the gradation value, in a dot pattern adjacency table.

12. The method as defined in claim 11, wherein the dot patterns are generated by dividing up a dot image that has been subjected to halftoning process by one of an error diffusion method and a blue noise mask method, into pixel blocks of a prescribed size, and the information indicating the adjacency relationships is obtained from an arrangement of the dot patterns on this dot image.

13. A computer readable medium having embodied thereon a dot pattern adjacency table creating program for performing by a computer, the program comprising:
a first code segment for a pattern generation step of generating dot patterns of a pixel block composed of a plurality of binary pixels, which represent a tonal gradation corresponding to a multiple-value gradation value;
a second code segment for an adjacency relationship acquisition step of acquiring information indicating adjacency relationships between dot patterns that are capable of being arranged in mutually adjacent positions; and
a third code segment for a registration step of registering the information indicating the adjacency relationships, and the dot patterns, in association with the gradation value, in a dot pattern adjacency table.
